(19) United States
(12) Patent Application Publication
(10) Pub. No.: US 2020/0356931 A1
(43) Pub. Date: Nov. 12, 2020

(54) RESOURCE MEDIATION SYSTEM AND RESOURCE MEDIATION APPARATUS

(71) Applicant: HITACHI, LTD., Tokyo (JP)

(72) Inventors: Tomoichi EBATA, Tokyo (JP); Tatsuhiro SATOU, Tokyo (JP); Yoshiyasu TAKAHASHI, Tokyo (JP); Kojin YANO, Tokyo (JP)

(73) Assignee: HITACHI, LTD., Tokyo (JP)

(21) Appl. No.: 16/760,434

(22) PCT Filed: Nov. 5, 2018
(86) PCT No.: PCT/JP2018/040928

§ 371 Date: Apr. 29, 2020

(30) Foreign Application Priority Data
Nov. 10, 2017 (JP) 2017-216936
Jan. 24, 2018 (JP) 2018-009414

(51) Int. Cl. G06Q 10/06; H04L 29/08; G06Q 50/30; G06Q 50/18; G06F 30/20

(52) U.S. Cl. CPC G06Q 10/06315; H04L 67/12; G06Q 50/30; G06F 2119/12; G06Q 50/182; G06F 30/20; G06Q 2240/00; G06Q 10/067

(57) ABSTRACT

Supply and demand of resources are controlled while satisfying both a resource providing condition and a resource use condition.

A resource mediation server 1 predicts an arrival clock time in a case of no occurrence of a railway car accident P3, an arrival clock time after recovery from the railway car accident P3, and an arrival clock time in a case of using a special bus on the basis of a damage scale due to the railway car accident P3, delivers prediction information to each passenger, delivers a special bus service plan to a bus company, provides a condition for using the special bus to the passenger and the bus company on the basis of the prediction information about the arrival clock time, and conducts mediation of the number of special buses and a fare of each special bus between the passenger and the bus company.

### TECHNICAL FIELD

The present invention relates to a resource mediation system and a resource mediation apparatus capable of controlling supply and demand of resources.

### BACKGROUND ART

In recent years, the mass production economic model has reached a limit, and service-oriented businesses have attracted an attention to accompany a rise of recycling-oriented economy for recycling resources. Among other things, in service-oriented social transportation infrastructure, sharing of means of transportation and movement (such as motor vehicles) that used to be products for sale and substitution of things are ongoing.

Patent Document 1 discloses a technology for mobilizing a special vehicle in a case of determining that a bus traveling on a service route in accordance with a timetable does not arrive at a check point at a predetermined clock time.

Patent Document 2 discloses a technology for formulating a taxi ride sharing service plan by referring to stored information about past moving paths, formulating a moving plan, and then transmitting a request for ride sharing to a terminal of an owner that provides a vehicle.

Patent Document 3 discloses a technology for reproducing and evaluating a traffic situation by computer simulation using virtual vehicle objects.

### PRIOR ART DOCUMENT

### Patent Documents

Patent Document 1: JP-2006-163738-A
Patent Document 2: JP-2015-191364-A
Patent Document 3: JP-2013-080272-A

### SUMMARY OF THE INVENTION

### Problems to be Solved by the Invention

However, with the technology disclosed in Patent Document 1, in a case in which a bus does not arrive on time, a special bus can be turned up as an alternative to the bus; however, the technology is incapable of handling a situation in which passengers who are unable to move grow in number on a geographical plane basis from a point at which a railway car stop accident has occurred at a time of the occurrence of the railway car stop accident or the like.

With the technology disclosed in Patent Document 2, it is possible to enhance utilization efficiency of taxis and passengers by the ride sharing; however, it is difficult to acquire alternative means of transportation for passengers in the order of a several hundred to a several thousand involved at the time of occurrence of the railway car stop accident or the like before time of recovery from the railway car stop accident.

In other words, if separate taxis and passengers use or provide taxis independently and individually, an enormous amount of patterns of mediation are generated. In a case like this, it is highly likely that a wag-the-dog situation in which waiting for the recovery from the stop accident of the railway car is an earlier solution or a more cost effective solution occurs. Furthermore, it is highly likely that passengers hesitate to use taxis since a predicted arrival time of a taxis is unknown to taxi users.

Moreover, the invention of Patent Document 3 can realize the traffic situation by the computer simulation; however, the invention is incapable of formulating a special bus service plan for more passengers to arrive at destinations in a shorter time at the time of occurrence of the railway car stop accident or the like.

The present invention has been achieved in light of the circumstances described above, and an object of the present invention is to provide a resource mediation system and a resource mediation apparatus capable of controlling supply and demand of resources while satisfying both a resource use condition and a resource providing condition.

### Means for Solving the Problems

To attain the object, a resource mediation system according to a first aspect includes: a first server that sets a providing condition and a use condition for a second resource on the basis of a first resource, and that conducts mediation of supply and demand of the second resource on the basis of the providing condition and the use condition; a second server that evaluates the providing condition for the second resource transmitted from the first server; and an information terminal that evaluates the use condition for the second resource transmitted from the first server.

### Advantages of the Invention

According to the present invention, it is possible to control supply and demand of resources while satisfying both a resource providing condition and a resource use condition.

### BRIEF DESCRIPTION OF THE DRAWINGS

FIG. 1 is a diagram depicting an example of a special bus service line at a time of occurrence of an accident on a railway line supposed in a resource mediation system according to a first embodiment.

FIG. 2 is a block diagram depicting a configuration of the resource mediation system according to the first embodiment.

FIG. 3 is a block diagram depicting a hardware configuration of servers used in the resource mediation system according to the first embodiment.

FIG. 4 is a block diagram depicting a configuration of a resource mediation server of FIG. 2.

FIG. 5 is a block diagram depicting a flow of processing by the resource mediation server of FIG. 4.

FIG. 6 is an explanatory diagram of destination arrival clock times of a virtual passenger object 13-6 of FIG. 4.

FIG. 7 is a block diagram depicting configurations of a railway service server 2, a bus service server 3, and an information terminal 4.

FIG. 8 is a block diagram depicting message communication processing by the resource mediation system of FIG. 2.

FIG. 9 is a diagram depicting a flow of actions by the resource mediation server of FIG. 4.

FIG. 10 is a block diagram depicting a flow of processing by a new transportation generation plan solver 13-1 of FIG. 4.

FIG. 11 is a diagram depicting an example of species used in the resource mediation system according to the first embodiment.

FIGS. 12A to 12D are diagrams depicting an example of a fuzzy rule table and membership functions used to determine a fare of a special bus used by the virtual passenger object 13-6 of FIG. 4.

FIGS. 13A and 13B are diagrams depicting correction coefficient tables used in a mediation coefficient correction section 13-3 of FIG. 4.

FIG. 14 is a diagram depicting a fuzzy rule table changed on the basis of the correction coefficient tables.

FIG. 15 is a diagram depicting an environmental condition during a railway service applied to the resource mediation system of FIG. 2.

FIG. 16 is a graph chart depicting a change in the number of passengers in a railway car on the move during occurrence of a railway car stop accident.

FIG. 17 is a graph chart depicting the number of passengers sojourning at stations E and F of FIG. 1.

FIG. 18 is a diagram depicting special bus service plan proposals produced by the resource mediation system of FIG. 2.

FIG. 19 is a diagram depicting time reduced by actual special buses proposed by the resource mediation system of FIG. 2.

FIG. 20 is a diagram depicting changes in the number of passengers sojourning at the station F depending on whether or not the service plan proposal produced by the resource mediation system of FIG. 2 is applied.

FIGS. 21A and 21B are diagrams depicting fares agreed in virtual mediation by the resource mediation system of FIG. 2.

FIG. 22 is a diagram depicting examples of a display screen of each information terminal 4 of FIG. 4.

FIG. 23 is a diagram depicting examples of a display screen of the bus service server 3 of FIG. 4.

FIG. 24 is a diagram depicting an example of a special bus service line at a time of occurrence of an accident on a railway line according to a second embodiment.

FIG. 25 is a diagram depicting station information about stations of FIG. 24.

FIG. 26 is a block diagram depicting a flow of processing at a time of creating a virtual mediation result by the resource mediation server according to the second embodiment.

FIG. 27 is a diagram depicting an example of data stored in a database of FIG. 26 and generated at a time of artificial occurrence of railway car stop accidents.

FIG. 28 is a block diagram depicting a flow up to actual mediation by the resource mediation server according to the second embodiment.

FIG. 29 is a diagram depicting an example of a relationship between points at which railway car accidents occurred in the past and a point at which a current railway car accident occurs, in the virtual mediation according to the second embodiment.

FIG. 30 is a diagram depicting examples of a method of calculating a virtual mediation result used in actual mediation by the resource mediation server according to the second embodiment.

FIG. 31A is a flowchart depicting a method of calculating a psychological virtual distance during rush hours, and FIG. 31B is a flowchart depicting a method of calculating delay-based virtual distance during a train delay.

### MODES FOR CARRYING OUT THE INVENTION

Embodiments will be described with reference to the drawings. The embodiments described hereinafter are not intended to limit the invention set forth in claims, and all of elements described in the embodiments and combinations thereof are not always essential to means for solving the problems by the invention.

It is described in a first embodiment below that a first resource is, for example, a railway and a second resource is, for example, a bus. However, if the second resource can be used as an alternative to the first resource, the first and second resources are not limited to the railway and the bus. For example, the resources are not necessarily transportation infrastructure and may be social infrastructure such as electric power and telecommunications.

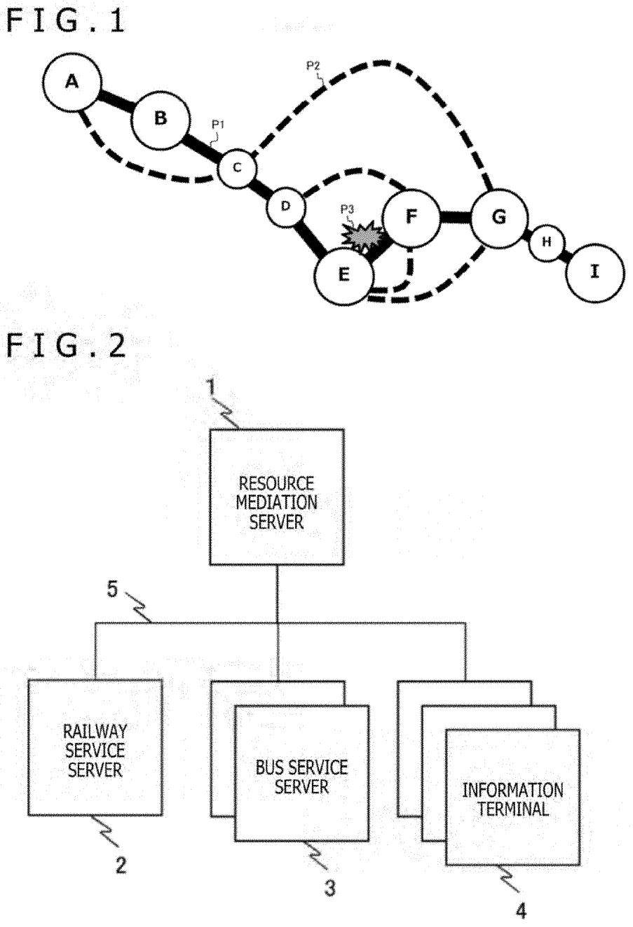

FIG. 1 is a diagram depicting an example of a special bus service line at a time of occurrence of an accident on a railway line supposed in a resource mediation system according to the first embodiment.

In FIG. 1, stations A to I are provided on a railway line P1. While FIG. 1 illustrates an example of providing the nine stations A to I on the railway line P1, two or more stations may be provided on the railway line P1. In addition, the railway line P1 may branch off.

In a case, for example, in which a railway car accident P3 has occurred between the stations E and F, it is possible to set a special bus service line P2 between the stations A and I on the railway line P1. It is noted that the railway car accident P3 may be a power failure accident, a traffic light trouble, a turnout failure, an accident resulting in injury or death, a railway crossing accident, or the like. Alternatively, the railway car accident P3 may be a case of stopping a railway car due to heavy rain, snow, strong wind, or the like.

If the railway car accident P3 occurs, not only a railway car traveling between the stations E and F but also railway cars traveling in sections before the station E are stopped. All railway cars are stopped on the railway line P1 depending on circumstances. To address such a problem, the special bus service line P2 can be set to straddle a section between the stations E and F or can be set not to straddle the section between the stations E and F.

Furthermore, while FIG. 1 illustrates a method of setting the special bus service line P2 between the stations A and I on the railway line P1 at which the railway car accident P3 has occurred, a delay due to the railway car accident P3 often exerts an influence on a case of transfer from the railway line P1 to the other railway line. Owing to this, the special bus service line P2 may contain stations on railway lines other than the railway line P1 at which the railway car accident P3 has occurred.

An outline of the method of setting the special bus service line P2 will be described hereinafter.

When the railway car accident P3 occurs, a damage scale due to the railway car accident P3 is predicted. In addition, an arrival clock time t1 in a case of no railway car accident P3, an arrival clock time t2 after recovery from the railway car accident P3, and an arrival clock time t3 in a case of using a special bus before the recovery from the railway car accident P3 are predicted on the basis of the damage scale, prediction information is delivered to each passenger, and a special bus service plan is delivered to a bus company.

Next, on the basis of the prediction information about the arrival clock times t1, t2, and t3, a special bus use condition is presented to each passenger, a special bus providing condition is presented to the bus company, and mediation of the number of special buses and fares is conducted between the passenger and the bus company.

Upon completion of the mediation of the number of special buses and the fares thereof, an actual special bus service is started.

An example of an environmental condition supposed in the resource mediation system is as follows.

Railway line distance: approximately 30 km
Total number of users: approximately 50,000 users/day
Service hours: approximately 18 hours/day
Number of available special buses: ten buses at each station.

The resource mediation system can conduct mediation between each passenger and the bus company on the basis of the special bus use condition and the special bus providing condition. The resource mediation system can thereby formulate a rational special bus service plan in a short time required for the recovery from the railway car accident P3 in such a manner that as many passengers as possible arrive at destinations as quickly as possible.

FIG. 2 is a block diagram depicting a configuration of the resource mediation system according to the first embodiment.

In FIG. 2, the resource mediation system is provided with a resource mediation server 1, a railway service server 2, bus service servers 3, and information terminals 4. A mobile terminal used by each passenger using a railway or a bus can be used as each information terminal 4. The resource mediation server 1 is connected to the railway service server 2, the bus service servers 3, and the information terminals 4 by a network 5. A form of connection of the network 5 is not limited to a specific form and may be wireless connection, wired connection, or the like.

The resource mediation server 1 can predict the arrival clock time t1 in the case of no railway car accident P3, the arrival clock time t2 after the recovery from the railway car accident P3, and the arrival clock time t3 in the case of using the special bus before the recovery from the railway car accident P3 on the basis of the damage scale due to the railway car accident P3, deliver the prediction information to each information terminal 4, and deliver the special bus service plan to each bus service server 3. In addition, the resource mediation server 1 can present the special bus use condition to the information terminal 4, present the special bus providing condition to the bus service server 3, and conduct mediation of the number of special buses and the fares thereof between each passenger and the bus company on the basis of the prediction information about the arrival clock times t1, t2, and t3.

The railway service server 2 can manage a railway service schedule on an appointed day, and transmit railway car stop accident information and expected time of the recovery from the railway car stop accident information.

The bus service server 3 can transmit information about the number of buses available as special buses, places of the buses, and the like. The bus service server 3 can also receive the special bus service plan and transmit information about whether or not to accept the service plan. This service plan can contain the special bus providing condition.

Each information terminal 4 can transmit current position information about each passenger using the railway or the bus and the like. In addition, the information terminal 4 can receive the special bus use condition and transmit information about whether or not to accept the use condition.

The resource mediation server 1 can conduct herein virtually conducted mediation (hereinafter, referred to as “virtual mediation”) and actually conducted mediation (hereinafter, referred to as “actual mediation”) at a time of conducting mediation of the number of special buses and the fares thereof between the passenger and the bus company.

The “virtual mediation” means generating objects corresponding to things in an actual world within the resource mediation server 1 and conducting mediation via the objects. The objects refer to fixed memory areas, such as instances in object-oriented programming, for storing information about the things in the real world.

A virtual world created by the resource mediation server 1 by a plurality of objects generated in this way will be referred to as “virtual space,” hereinafter.

A “virtually present passenger” in the present embodiment is an object generated in the resource mediation server 1 and having information about each passenger in the real world. The “virtually present passenger” basically acquires information (such as position information) about each actually present passenger or updates information about the object in accordance with a virtual space environment.

For example, when a passenger in the real world passes through an automatic turnstile at a departure station, a “virtually present passenger” simulating the passenger in the real world may be generated in the virtual space.

In a case in which the “virtually present passenger” gets aboard a “virtual train” traveling in the virtual space, position information about the “virtually present passenger” matches the “virtual train.” When the “virtually present passenger” is waiting for a “virtually present bus” at a virtually present bus stop, the position information about the “virtually present passenger” corresponds to the “virtually present bus stop.”

Alternatively, in a case in which a passenger in the real world carries a position information device such as a smartphone, the position information about the passenger in the real world may be updated as the position information about the “virtually present passenger.”

When the passenger in the real world passes through an automatic turnstile at an arrival station, the “virtually present passenger” simulating the passenger in the real world may be deleted.

In the virtual mediation, the special bus use condition is presented to each virtually present passenger (hereinafter, referred to as “virtual passenger”), and the special bus providing condition is presented to a virtually present bus company (hereinafter, referred to as “virtual bus company”). In addition, the virtual mediation of the number of special buses and the fares thereof can be conducted between the virtual passenger and the virtual bus company.

In the actual mediation, the special bus use condition obtained in the virtual mediation is presented to each actually present passenger (hereinafter, referred to as “actual passenger”), and the special bus providing condition obtained in the virtual mediation is presented to an actually present bus company (hereinafter, referred to as “actual bus company”). In addition, the actual mediation of the number of special buses and the fares thereof can be conducted between the actual passenger and the actual bus company.

Conducting herein the virtual mediation before the actual mediation makes it possible to converge early on into a virtual bus use condition and a virtual bus providing condition in such a manner that it is possible to reach an agreement between each virtual passenger and the virtual bus company over the virtual bus providing condition and the virtual bus use condition on the virtual space in a computer. At this time, in the actual mediation, the actual passenger and the actual bus company can make only determinations as to whether or not to accept the special bus providing condition and the special bus use condition obtained in the virtual mediation. Owing to this, it is possible to formulate the rational special bus service plan in a short time required for the recovery from the railway car accident P3 in such a manner that as many passengers sojourning due to the railway car accident P3 as possible arrive at destinations as quickly as possible.

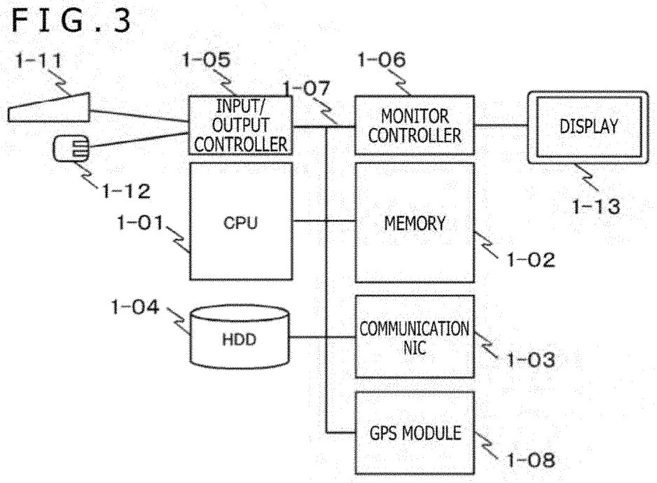

FIG. 3 is a block diagram depicting a hardware configuration of servers used in the resource mediation system according to the first embodiment.

The hardware of FIG. 3 can be used for the resource mediation server 1, the railway service server 2, and the bus service server 3 of FIG. 2. A CPU 1-01, a memory 1-02, a communication NIC (Network Interface Server) 1-03, a hard disk drive (hereinafter, referred to as “HDD”) 1-04, an input/output controller 1-05, and a monitor controller 1-06 are mutually connected by a bus 1-07 or the like. The input/output controller 1-05 is connected to a keyboard 1-11 and a mouse 1-12. The monitor controller 1-06 is connected to a display 1-13.

The CPU 1-01 is hardware that exercise control over entire actions of each server. The memory 1-02 is configured from, for example, a semiconductor memory and can temporarily hold various programs and control data. The HDD 1-04 can hold execution files for the various programs and the like. The HDD may be an SSD (Solid State Drive). The communication NIC 1-03 can connect an apparatus such as a computer to a communication network.

The HDD 1-04 of the resource mediation server can store therein a resource mediation program for predicting the arrival clock time in the case of no railway car accident P3, the arrival clock time after the recovery from the railway car accident P3, and the arrival clock time in the case of using a special bus before the recovery from the railway car accident P3, and conducting mediation of the number of special buses and the fares thereof between each passenger and the bus company on the basis of the prediction information.

The HDD 1-04 of the railway service server 2 can store therein a railway service management program for managing the railway service schedule and predicting the expected time of the recovery from the railway car stop accident.

The HDD 1-04 of the bus service server 3 can store therein a bus service management program for managing the number of buses available as special buses and places of the buses, receiving the special bus providing condition, and responding to the providing condition.

A touch panel is provided in each information terminal 4 of FIG. 2 as an alternative to the keyboard 1-11, the mouse 1-12, and the display 1-13. Furthermore, a GPS module 1-08 is provided in the information terminal 4. A hardware configuration of the information terminal 4 is identical to the hardware configuration described above except for these elements.

The HDD 1-04 of each information terminal 4 can store therein a passenger information management program for transmitting the current position information and the like about each passenger using a railway or a bus, receiving the special bus use condition, and responding to the use condition.

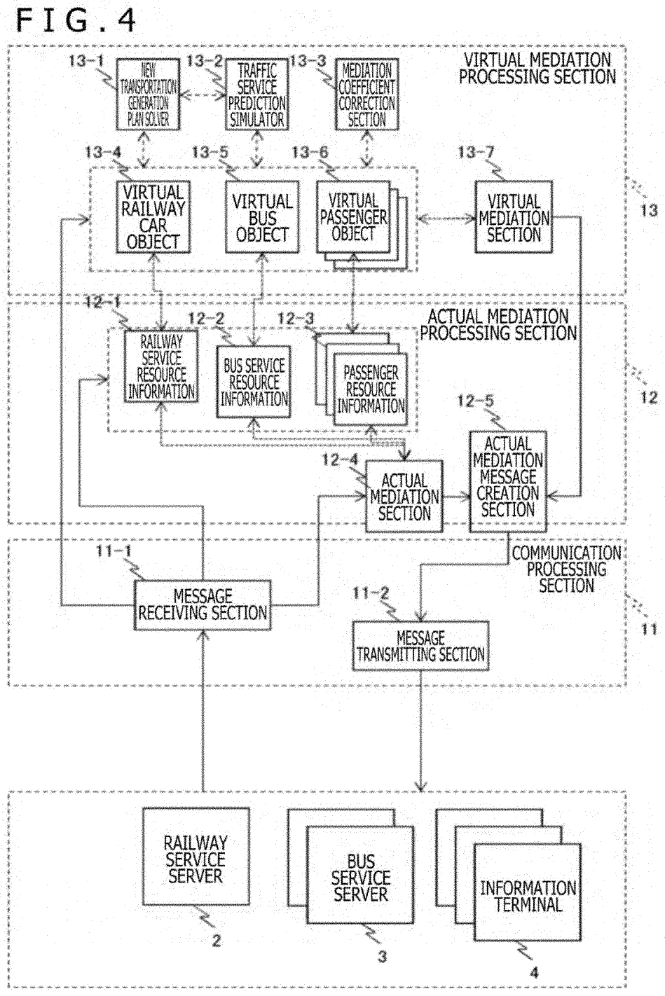

FIG. 4 is a block diagram depicting a configuration of the resource mediation server of FIG. 2.

In FIG. 4, the resource mediation server 1 is provided with a communication processing section 11, an actual mediation processing section 12, and a virtual mediation processing section 13.

The communication processing section 11 holds communication with the railway service server 2, the bus service server 3, and each information terminal 4. The communication processing section 11 is provided with a message receiving section 11-1 and a message transmitting section 11-2. The message receiving section 11-1 receives messages transferred from the railway service server 2, the bus service server 3, and each information terminal 4. The message transmitting section 11-2 transmits messages to the bus service server 3 and each information terminal 4.

The actual mediation processing section 12 conducts actual mediation between each actual passenger and the actual bus company on the basis of a virtual mediation result by the virtual mediation processing section 13. At this time, the actual mediation processing section 12 can refrain from the actual mediation in a case in which the virtual mediation is unsuccessful.

The actual mediation processing section 12 is provided with railway service resource information 12-1, bus service resource information 12-2, passenger resource information 12-3, an actual mediation section 12-4, and an actual mediation message creation section 12-5.

The railway service resource information 12-1 holds railway car stop accident information and the expected time of the recovery from the railway car stop accident. The bus service resource information 12-2 holds the number of buses available as special buses and the places of the buses. The passenger resource information 12-3 holds starting station information, arrival station information, or current position information about each passenger. The actual mediation section 12-4 executes actual mediation on the basis of declarations of intention from the actual passenger and the actual bus company. The actual mediation message creation section 12-5 creates an actual mediation message corresponding to a content of the virtual mediation.

The virtual mediation processing section 13 conducts virtual mediation between each virtual passenger and the virtual bus company. At this time, the virtual mediation processing section 13 can set N (where N is an integer equal to or greater than two) different providing conditions and N different use conditions for special buses, and conduct the virtual mediation on the basis of the N different providing conditions and the N different use conditions for special buses. The virtual mediation processing section 13 is provided with a new transportation generation plan solver 13-1, a traffic service prediction simulator 13-2, a mediation coefficient correction section 13-3, a virtual railway car object 13-4, a virtual bus object 13-5, virtual passenger objects 13-6, and a virtual mediation section 13-7.

The new transportation generation plan solver 13-1 formulates placement and a service plan of the virtual bus object 13-5 for special buses. The traffic service prediction simulator 13-2 performs prediction of a service of the virtual railway car object 13-4. The mediation coefficient correction section 13-3 changes a mediation correction coefficient in the virtual mediation. At this time, the mediation coefficient correction section 13-3 can change the mediation correction coefficient so as to satisfy both the special bus use conditions of each virtual passenger and the special bus providing conditions of the virtual bus company. The virtual railway car object 13-4 determines a place of a railway car on the move. The virtual bus object 13-5 determines whether or not to provide special buses by the virtual bus company or determines fares in a case of providing the special buses. Each virtual passenger object 13-6 determines whether or not each virtual passenger uses a special bus or determines a fare in a case of using the special bus. The virtual mediation section 13-7 conducts virtual mediation between the virtual passenger object 13-6 and the virtual bus object 13-5.

Actions by the resource mediation system of FIG. 4 will be described hereinafter in detail.

When information about the number of buses available as special buses and the places of the buses are transferred from the bus service server 3 via the message receiving section 11-1, the information about the number and the places are stored in the bus service resource information 12-2 of the actual mediation processing section 12.

In addition, when the starting station information, the arrival station information, or the current position information about an owner of each information terminal 4 is transferred from each information terminal 4 via the message receiving section 11-1, the information is stored in the passenger resource information 12-3 of the actual mediation processing section 12.

Furthermore, when the railway car stop accident information and the expected time of the recovery from the railway car stop accident are transferred from the railway service server 2 via the message receiving section 11-1, the information is stored in the railway service resource information 12-1 of the actual mediation processing section 12.

These pieces of stored information are also stored in the virtual railway car object 13-4, the virtual bus object 13-5, and each virtual passenger object 13-6 of the virtual mediation processing section 13. In a case in which the virtual railway car object 13-4, the virtual bus object 13-5, and the virtual passenger object 13-6 are not present, the virtual railway car object 13-4, the virtual bus object 13-5, and the virtual passenger object 13-6 are newly created by the virtual mediation processing section 13.

When the virtual mediation processing section 13 receives the railway car stop accident information from the railway service server 2, the traffic service prediction simulator 13-2 starts operation.

The traffic service prediction simulator 13-2 conducts a traffic service prediction simulation since timing of occurrence of the railway car stop accident until predetermined time after the expected time of the recovery from the railway car stop accident using the virtual railway car object 13-4, the virtual bus object 13-5, and each virtual passenger object 13-6.

The traffic service prediction simulation is conducted retrospectively to the timing of occurrence of the railway car stop accident for the following three cases.

(A) Case in which the railway car stop accident has not occur.
(B) Case in which the railway car stop accident has occurred.
(C) Case in which the railway car stop accident has occurred and special buses indicated by the new transportation generation plan solver 13-1 of the virtual mediation processing section 13 has traveled.

A method of an inference engine having a unique criterion for determination is provided in each of the virtual bus object 13-5 and the virtual passenger object 13-6.

Upon receiving traffic service prediction simulation results for the three cases (A) to (C) described above, the virtual bus object 13-5 determines whether or not the virtual bus company provides special buses or determines fares in a case of providing the special buses, and each virtual passenger object 13-6 determines whether or not the virtual passenger uses a special bus or determines a fare in a case of using a special bus. In a case of determining the fares of the special buses, the virtual bus object 13-5 can refer to a benefit of each passenger at the time of using the special bus. The benefit of the passenger in this case can be defined as reduced time of time required for arrival at the time of using a special bus.

Upon receiving determinations of the virtual bus object 13-5 and each virtual passenger object 13-6, the virtual mediation section 13-7 conducts virtual mediation between the determination of the virtual bus object 13-5 and the determination of the virtual passenger object 13-6. In addition, the virtual mediation section 13-7 repeatedly conducts the virtual mediation until an agreement is reached between the determination of the virtual bus object 13-5 and the determination of the virtual passenger object 13-6. The determination of the virtual bus object 13-5 and the determination of the virtual passenger object 13-6 can be made on the basis of a fare in a case in which the virtual bus company provides a special bus and a fare in a case in which each virtual passenger uses the special bus. At this time, the virtual mediation section 13-7 can repeatedly conduct the virtual mediation until an agreement is reached between the virtual bus object 13-5 and the virtual passenger object 13-6 for the fare in the case in which the virtual bus company provides a special bus and the fare in the case in which the virtual passenger uses the special bus.

When the virtual mediation between the virtual bus object 13-5 and the virtual passenger object 13-6 converges, the virtual mediation section 13-7 passes a mediation result of the virtual mediation to the actual mediation message creation section 12-5. The actual mediation message creation section 12-5 creates a mediation message addressed to each actual passenger and the actual bus company on the basis of the mediation result. The mediation message is transmitted to the bus service server 3 and each information terminal 4 via the message transmitting section 11-2.

The message may be a message that can be displayed on a screen of a web browser or the like of the information terminal 4 owned by the actual passenger or on a screen of the bus service server 3 of the actual bus company, as a specific content of the message.

The actual passenger and the actual bus company each operate the screen of the information terminal 4 or the bus service server 3, and transmit a reply message that conveys an actual own intention to the resource mediation server 1. The reply message is received by the message receiving section 11-1 and the message receiving section 11-1 passes the reply message to the actual mediation section 12-4.

The actual mediation section 12 conducts actual mediation between the actual passenger and the actual bus company while referring to the railway service resource information 12-1, the bus service resource information 12-2, and the passenger resource information 12-3. The actual mediation message creation section 12-5 creates a mediation message addressed to the actual passenger and the actual bus company on the basis of a mediation result of the actual mediation. The mediation message is transmitted to the bus service server 3 and each information terminal 4 via the message transmitting section 11-2, and the actual mediation between the actual passenger and the actual bus company can be repeatedly conducted.

In a case of a failure in the actual mediation between the actual passenger and the actual bus company, it is presumed that an assumption condition for the virtual mediation is wrong. Therefore, in the case of the failure in the actual mediation, the mediation coefficient correction section 13-3 changes the mediation correction coefficient corresponding to the virtual passenger object 13-6 or the virtual bus object 13-5. In addition, the mediation coefficient correction section 13-3 records the correction coefficient thus changed in the correction coefficient table in the HDD 1-04 of FIG. 3 together with a unique ID that identifies the virtual passenger or the virtual bus, and the virtual mediation section 13-7 attempts virtual mediation using the mediation correction coefficient changed, at a next time of the virtual mediation. As this mediation correction coefficient, a discount rate of each fare in the case in which the virtual bus company provides a special bus and a discount rate of a fare in the case in which the virtual passenger uses a special bus can be set.

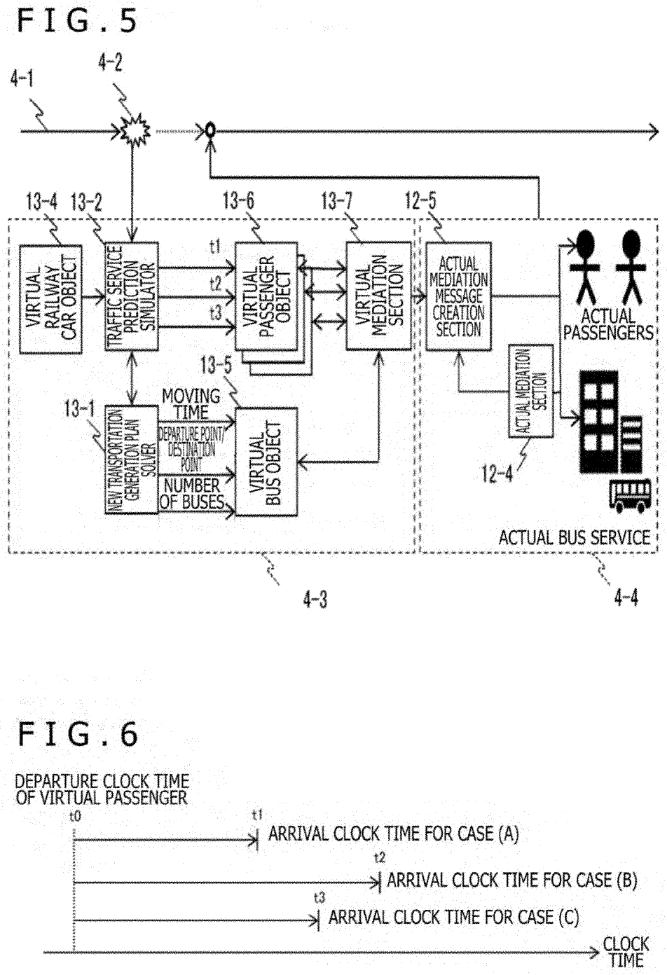

FIG. 5 is a block diagram depicting a flow of processing by the resource mediation server of FIG. 4.

On a time base 4-1 of an actual world of FIG. 5, before occurrence of the railway car stop accident P3, the resource mediation server 1 of FIG. 4 grasps, in real time, a position of the railway car on the move, a position of each passenger on the move, and positions or the number of buses available as special buses. The virtual railway car object 13-4, each virtual passenger object 13-6, and the virtual bus object 13-5 are created in a memory space within the resource mediation server 1.

It is assumed that the virtual railway car object 13-4 always records the position of the railway car on the move, the virtual passenger object 13-6 always records the position of the passenger on the move, and the virtual bus object 13-5 always records the positions or the number of buses available as special buses.

In addition, when the railway car stop accident P3 occurs at a clock time 4-2 on the time base 4-1 of the actual world, a phase of the resource mediation server 1 transitions to a virtual service phase 4-3. In the virtual service phase 4-3, the traffic service prediction simulator 13-2 is activated and performs prediction of a service of the virtual railway car object 13-4. The traffic service prediction simulator 13-2 also performs prediction of an arrival clock time of each virtual passenger object 13-6 on the basis of the prediction of the service of the virtual railway car object 13-4. Furthermore, the new transportation generation plan solver 13-1 formulates the placement and the service plan of the virtual bus object 13-5 for each special bus on the basis of the prediction of the service of the virtual railway car object 13-4. In addition, the traffic service prediction simulator 13-2 further performs prediction of an arrival clock time of each virtual passenger object 13-6 in the case of using the service plan about the virtual bus object 13-5.

FIG. 6 is an explanatory diagram of destination arrival clock times of the virtual passenger object 13-6 of FIG. 4.

In FIG. 6, the traffic service prediction simulator 13-2 predicts the arrival clock times t1, t2, and t3 of each virtual passenger object 13-6 for the three cases (A) to (C) described above. In an example of FIG. 6, in the case in which the railway car stop accident 4-2 occurs and the special bus indicated by the new transportation generation plan solver 13-1 is used, the arrival clock time at a destination is earlier than that in the case in which the special bus is not used.

Each virtual passenger object 13-6 of FIG. 5 presents whether or not the virtual passenger uses the virtual bus object 13-5 corresponding to a virtual special bus or presents a fare of the virtual bus object 13-5 in the case of using the virtual bus object 13-5 on the basis of prediction of the arrival clock times t1, t2, and t3. The virtual bus object 13-5 of the virtual bus company presents whether or not the virtual bus company provides special buses or presents fares of the special buses in the case of providing the special buses with respect to a use plan of the virtual bus object 13-5 as special buses formulated by the new transportation generation plan solver 13-1.

The virtual mediation section 13-7 conducts virtual mediation between the virtual passenger object 13-6 and the virtual bus object 13-5 on the basis of the fare presented by the virtual passenger object 13-6 and the fares presented by the virtual bus object 13-5. The virtual mediation continues until there occurs a state in which an agreement is reached between the virtual passenger object 13-6 and the virtual bus object 13-5. The virtual service phase 4-3 is virtually conducted by the virtual railway car object 13-4, the virtual bus object 13-5, and each virtual passenger object 13-6 created in the memory space within the resource mediation server 1.

Upon completion of the virtual mediation in the virtual space, the resource mediation server 1 starts actual mediation in an actual service phase 4-4. In the actual service phase 4-4, the actual mediation message creation section 12-5 creates an actual mediation message corresponding to a content of the virtual mediation, and transfers a mediation proposal to each actual passenger and the actual bus company. The actual passenger makes a counterproposal of whether or not the actual passenger uses a special bus or of a fare of the special bus in response to the mediation proposal. Furthermore, the actual bus company makes a counterproposal of whether or not the actual bus company provides special buses or of fares of the special buses in the case of providing the special buses.

The actual mediation section 12 executes actual mediation on the basis of the counterproposals from the actual passenger and the actual bus company. After completion of the actual mediation in the actual service phase 4-4, the service of each special bus, the use by each passenger, and collection and retrieval of the fares according to the content of the meditation are conducted, and the actual mediation phase 4-4 returns to the original time base 4-1.

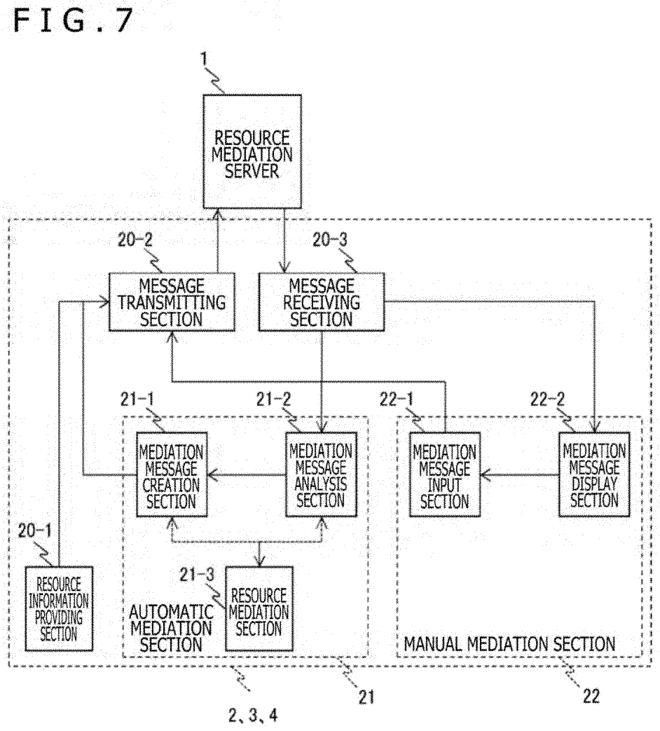

FIG. 7 is a block diagram depicting configurations of the railway service server 2, the bus service server 3, and the information terminal 4.

In FIG. 7, a resource information providing section 20-1, a message transmitting section 20-2, a message receiving section 20-3, an automatic mediation section 21, and a manual mediation section 22 are provided in each of the railway service server 2, the bus service server 3, and the information terminal 4.

A mediation message creation section 21-1, a mediation message analysis section 21-2, and a resource mediation section 21-3 are provided in the automatic mediation section 21. A mediation message input section 22-1 and a mediation message display section 22-2 are provided in the manual mediation section 22.

The resource information providing section 20-1 of the railway service server 2 provides traveling railway car information and a schedule on an appointed day to the resource mediation server 1 at initial time, and provides position information about the traveling railway car to the resource mediation server 1 on a regular basis.

The resource information providing section 20-1 of the bus service server 3 provides the number of available buses and position information about the buses to the resource mediation server 1 at the initial time and on a regular basis.

The resource information providing section 20-1 of the information terminal 4 provides position information about or names of a point of departure and a destination of the owner of the information terminal 4 to the resource mediation server 1 at the initial time, and provides position information about the information terminal 4 to the resource mediation server 1 on a regular basis.

In the actual mediation phase of the resource mediation server 1, the bus service server 3 and the information terminal 4 each receive a mediation message via the message receiving section 20-3. In this case, the bus service server 3 and the information terminal 4 can each select whether to conduct automatic mediation or manual mediation.

In a case of selecting the manual mediation, the manual mediation section 22 conducts manual mediation. At this time, an operator of each of the bus service server 3 and the information terminal 4 creates a response from the mediation message input section 22-1 in response to a display content of the mediation message display section 22-2, and transmits the response via the message transmitting section 20-2. The operator can perform these operations on, for example, the screen of the web browser of the information terminal 4 owned by each actual passenger or of the bus service server 3 of the actual bus company.

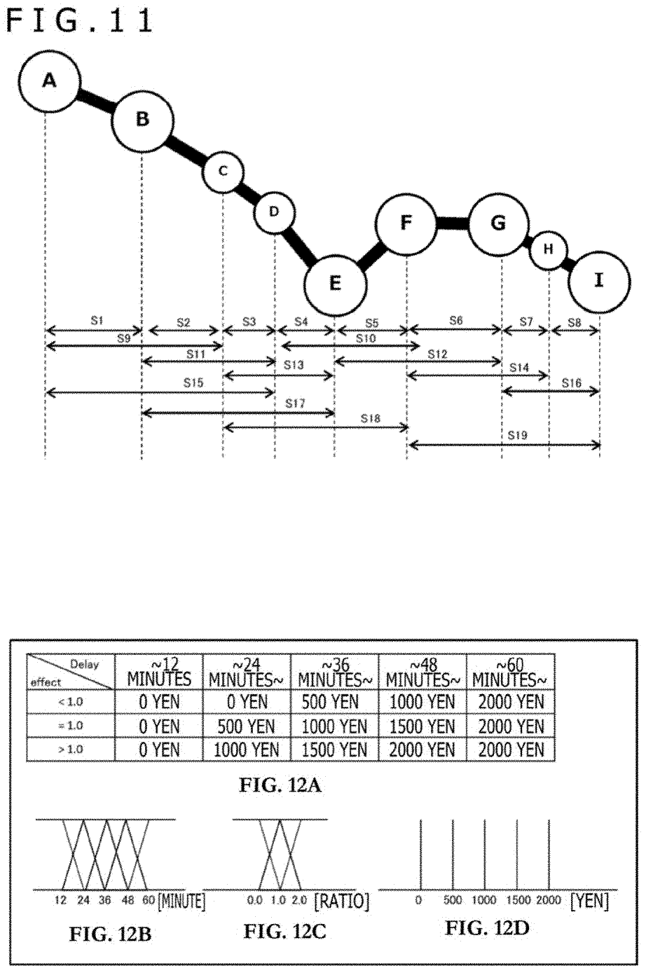

On the other hand, in a case of selecting the automatic mediation, the automatic mediation section 21 conducts automatic mediation. At this time, the operator does not perform any operations, and the mediation message analysis section 21-2 analyzes a mediation message while referring to a mediation content of the resource mediation section 21-3. The mediation message creation section 21-1 then creates a response to the mediation message on the basis of an analysis result of the mediation message analysis section 21-2, and transmits the response via the message transmitting section 20-2. It is noted that an inference engine operating on the basis of a fuzzy rule table and membership functions of FIGS. 12A to 12D can be used as a mode for realizing the resource mediation section 21-3.

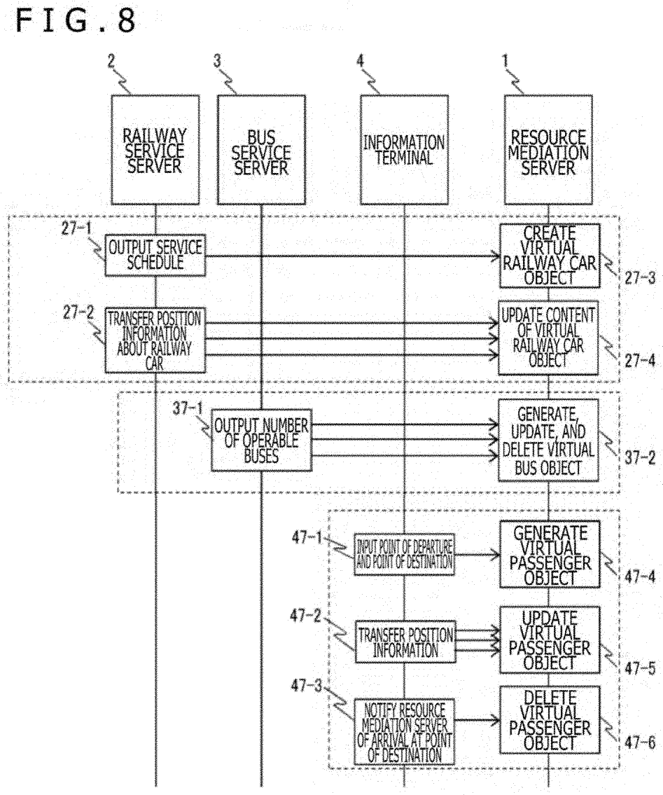

FIG. 8 is a block diagram depicting message communication processing by the resource mediation system of FIG. 2.

In FIG. 8, when the resource mediation server 1 participates in the resource mediation system or while the railway car accident P3 does not occur, the resource mediation server 1 communicates messages with the railway service server 2, the bus service server 3, and each information terminal 4.

At the time of participating in the resource mediation system, the railway service server 2 transfers the service schedule on the appointed day to the resource mediation server 1 (27-1). At this timing, the resource mediation server 1 creates a plurality of virtual railway car objects 13-4 (27-3). In addition, the railway service server 2 transfers position information about all traveling railway cars to the resource mediation server 1 on a regular basis (27-2). The resource mediation server 1 updates contents of the virtual railway car objects 13-4 on the basis of the position information about the railway cars (27-4).

At the time of participating in the resource mediation system, the bus service server 3 transfers information about the number of buses that can travel and position information about the buses to the resource mediation server 1 (37-1). At this timing, the resource mediation server 1 creates a plurality of virtual bus objects 13-5 (37-2). In addition, the bus service server 3 transfers information about the number of buses that can travel and the position information about the buses to the resource mediation server 1 on a regular basis (37-1). At this time, the resource mediation server 1 performs addition and deletion of the virtual bus object 13-5 as needed (37-2).

At the time of participating in the resource mediation system, the information terminal 4 inputs position information about or names of the point of departure and the destination of the owner of the information terminal 4 (47-1). At this timing, the resource mediation server 1 generates the virtual passenger object 13-6 (47-4). Subsequently, the information terminal 4 continues to transfer the position information about the owner of the information terminal 4 on a regular basis (47-2), and the virtual passenger object 13-6 continues to be updated on the basis of the position information (47-5). When the information terminal 4 notifies the resource mediation server 1 of arrival of the point of destination (47-3), the resource mediation server 1 deletes the virtual passenger object 13-6 (47-6).

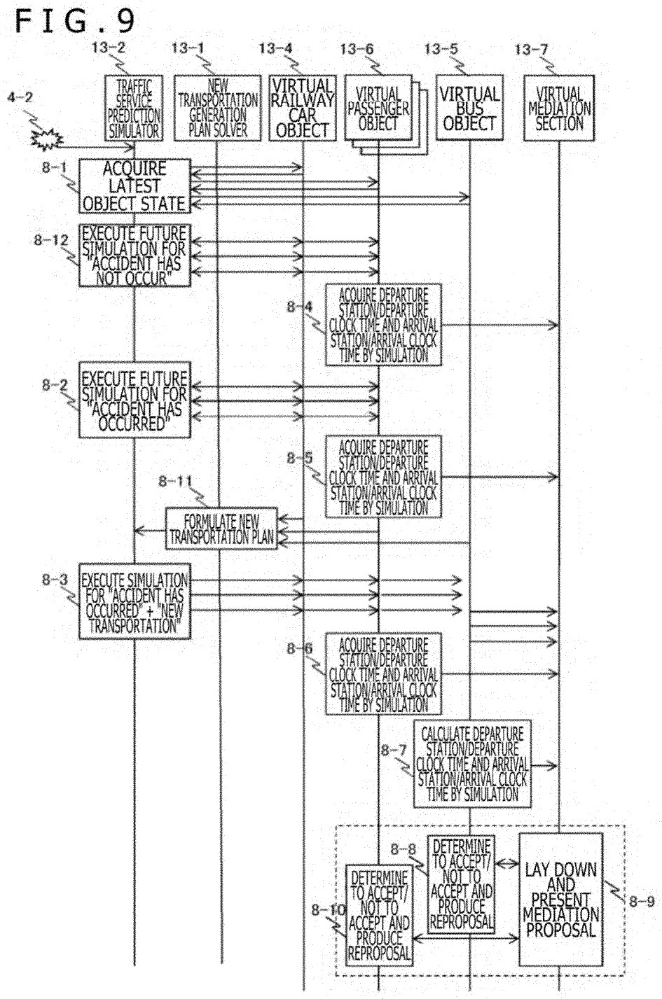

FIG. 9 is a diagram depicting a flow of actions by the resource mediation server of FIG. 4.

In FIG. 9, the resource mediation server 1 starts operation right after the occurrence of the railway car stop accident P3 at the clock time 4-2. At this time, the traffic service prediction simulator 13-2 receives a notification of the occurrence of the railway car stop accident P3 and then acquires latest states of each virtual railway car object 13-4, each virtual passenger object 13-6, and each virtual bus object 13-5 (8-1). The traffic service prediction simulator 13-2 then starts a traffic service prediction simulation in the “case (A) in which the railway car stop accident has not occur” (8-12).

The traffic service prediction simulator 13-2 carries out this traffic service prediction simulation since the time of the occurrence of the railway car stop accident P3 until the predetermined clock time (up to a last train clock time) after the recovery from the railway car stop accident P3.

Furthermore, the traffic service prediction simulator 13-2 generates dummy virtual passenger objects in units of fixed time for reproducing a situation after the occurrence of the railway car stop accident P3. As a generation/deletion schedule of the dummy virtual passenger objects, past passenger data in a time zone of the same day of week or the like may be used.

Through this traffic service prediction simulation, each virtual passenger object 13-6 can obtain the arrival clock time t1 at an arrival position (arrival station) in the “case (A) in which the “railway car accident” has not occur” (8-4). This arrival clock time t1 is transferred to the virtual mediation section 13-7 and then recorded in each virtual passenger object 13-6.

Next, the traffic service prediction simulator 13-2 starts a traffic service prediction simulation in the “case (B) in which the railway car stop accident has occurred” this time retrospectively to the railway car stop accident occurrence clock time 4-2 (8-2).

Through this traffic service prediction simulation, each virtual passenger object 13-6 can obtain the arrival clock time t2 at the arrival position (arrival station) in the “case (B) in which the railway car accident has occurred” (8-5). This arrival clock time t2 is transferred to the virtual mediation section 13-7 and then recorded in each virtual passenger object 13-6, similarly to the arrival clock time t1.

The new transportation generation plan solver 13-1 formulates herein a special bus service plan for special buses (hereinafter, referred to as “new transportation plan”) from a movement amount of each passenger in this “case (B) in which the railway car stop accident has occurred” and the positions and the number of buses available as special buses at the timing of the occurrence of the railway car stop accident (8-11).

Next, the traffic service prediction simulator 13-2 starts a traffic service prediction simulation in the “case (C) in which the railway car stop accident has occurred and special buses according to the new transportation plan has traveled” retrospectively again to the railway car stop accident occurrence clock time 4-2 (8-3).

Through the traffic service prediction simulation, each virtual passenger object 13-6 can obtain the arrival clock time t3 at the arrival position (arrival station) in the “case (C) in which the railway car accident has occurred and yet special buses according to the new transportation plan has traveled” (8-6). This arrival clock time t3 is transferred to the virtual mediation section 13-7 and then recorded in each virtual passenger object 13-6, similarly to the arrival clock times t1 and t2.

In this way, the arrival clock times t1, t2, and t3 at the destination of each virtual passenger object 13-6 in the three cases (A) to (C) are calculated. In addition, a service schedule and a service path of each virtual bus object 13-5 are calculated (8-7).

Next, each virtual passenger object 13-6 determines whether or not the virtual passenger object 13-6 uses a special bus and presents a fare in the case of using the special bus from the arrival clock times t1, t2, and t3 in the three cases (A) to (C) (8-10). In addition, each virtual bus object 13-5 determines whether or not the virtual bus object 13-5 provides special buses and presents a necessary expense for the buses in the case of providing the buses (8-8).

The virtual mediation section 13-7 mediates between each virtual passenger object 13-6 and each virtual bus object 13-5 and conducts virtual mediation in a virtual space in such a manner that an agreement of the fare is reached between the virtual passenger object 13-6 and the virtual bus object 13-5 (8-9).

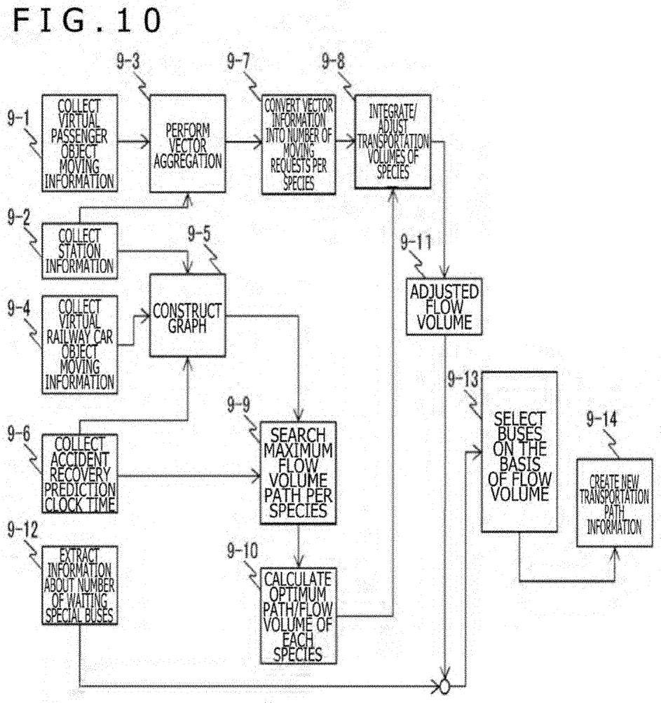

FIG. 10 is a block diagram depicting a flow of processing by the new transportation generation plan solver 13-1 of FIG. 4.

In FIG. 10, the new transportation generation plan solver 13-1 collects station information 9-2 and moving information 9-1 about each virtual passenger object 13-6, and aggregates the moving information 9-1 as vector information (9-3). The station information 9-2 can contain, for example, the number of boarding and alighting passengers per time zone at each of the stations A to I. The new transportation generation plan solver 13-1 then converts this vector information into the number of moving requests per species (9-7). It is noted that the species is a combination of two arbitrary stations.

FIG. 11 is a diagram depicting an example of species used in the resource mediation system according to the first embodiment.

In FIG. 11, species S1 to S19 can be obtained by combining two stations selected from among the stations A to I on the railway line P1. In the example of FIG. 11, combinations of two adjacent stations, combinations of two stations in a case of one station present therebetween, and combinations of two stations in a case of two stations present therebetween are illustrated. It is noted that combinations of two stations in a case of three or more stations present therebetween are also available.

Furthermore, in FIG. 10, the new transportation generation plan solver 13-1 collects the station information 9-2, moving information 9-4 about the virtual railway car object 13-4, and railway car stop accident recovery clock time information 9-6, and constructs a graph (9-5). The new transportation generation plan solver 13-1 searches a maximum flow volume path per species from the graph (9-9), and calculate an optimum path and an optimum flow volume of each species (9-10). The new transportation generation plan solver 13-1 then integrates and adjusts transportation volumes of the species on the basis of the optimum path, the optimum flow volume, and the number of moving requests of each species (9-8), and calculates an adjusted flow volume of each species (9-11).

At this time, the adjusted flow volume of each species can be varied depending on a time zone in which the railway car accident P3 has occurred. For example, the adjusted flow volume of each species can be increased in a case in which the railway car accident P3 has occurred in a commuting time zone, and can be reduced in a case in which the railway car accident P3 has occurred in the daytime.

Moreover, the adjusted flow volume of each species can be varied depending on the number of boarding and alighting passengers at each station. For example, the adjusted flow volume can be increased for the species including the station at which the number of boarding and alighting passengers is large, and can be reduced for the species including only the stations at each of which the number of boarding and alighting passengers is small.

Furthermore, the new transportation generation plan solver 13-1 extracts information about the number of waiting special buses 9-12 from the virtual bus objects 13-5, selects buses on the basis of the adjusted flow volume of each species 9-11 (9-13), and creates new transportation path information 9-14 on the basis of this information.

Mediation processing by the virtual mediation section 13-7 will be described hereinafter in detail while referring to specific examples.

FIGS. 12A to 12D are diagrams depicting an example of a fuzzy rule table and membership functions used to determine a fare of a special bus used by each virtual passenger object 13-6 of FIG. 4.

In FIG. 12A, the fuzzy rule table for fares that can be paid by each virtual passenger object 13-6 for using a special bus and the membership function of the antecedent and the consequent of fuzzy inference can be set from a Delay (minute) that is a difference in arrival time between the cases (C) and (B) and an effect that is a ratio of a difference in arrival time between the cases (C) and (A) to the difference in arrival time between the cases (C) and (B).

It is noted that FIG. 12B depicts the membership function for the Delay (minute), FIG. 12C depicts the membership function for the ratio that is the effect, and FIG. 12D depicts the membership function for the fare in the case in which each passenger uses a special bus.

In the fuzzy rule table of FIG. 12A, it is specified that a payment is zero yen in a case, for example, in which the arrival clock time is rather late by passenger's using a special bus. Owing to this, each virtual passenger object 13-6 can determine not to use a special bus.

Furthermore, it is possible to specify in the fuzzy rule table that a motivation to pay a fare is generated in a case in which a sixty minutes delay is generated due to an influence of the railway car stop accident and the delay can be reduced to thirty minutes by using a special bus. Moreover, it is possible to specify in the fuzzy rule table that the motivation to pay a fare to a special bus is not generated in a case in which a ninety minutes delay due to the railway car stop accident is reduced only to an eighty minutes delay by using a special bus.

On the other hand, in the case of the virtual bus object 13-5, it is possible to set a simple rule that special buses are allowed to travel if, for example, a value obtained by multiplying bus service time (hours) by 10,000 yen is added to 20,000 yen (fixed cost) and an amount exceeding an amount 1.2 (profitability rate of 20%) times as high as an addition value can be collected.

The virtual mediation section 13-7 can conduct the following calculation and mediation with respect to determinations of the virtual passenger object 13-6 and the virtual passenger object 13-5.

(Case K1) It is assumed that a total amount of presented amounts by the virtual passenger objects 13-6 hoping to get aboard a certain virtual bus object 13-5 exceeds an amount expected by the virtual bus object 13-5. In this case, the virtual mediation section 13-7 proposes an amount obtained by dividing the amount expected by the virtual bus object 13-5 by the number of virtual passenger objects to each virtual passenger object 13-6, and proposes the amount as presented to the virtual bus object 13-5.

The case K1 basically acts to reduce the fare for the virtual passenger object 13-6. Owing to this, it is considered that not only the virtual bus object 13-5 but also each virtual passenger object 13-6 tend to accept this proposal.

(Case K2) It is assumed that the total amount of the presented amounts by the virtual passenger objects 13-6 hoping to get aboard the certain virtual bus object 13-5 is below the amount expected by the virtual bus object 13-5. In this case, the virtual mediation section 13-7 can offer a proposal to each virtual bus object 13-6 a fare raise up to 15% of an amount obtained by dividing the amount expected by the virtual bus object 13-5 by the number of virtual passenger objects, and also offer a proposal to the virtual bus object 13-5 a fare reduction down to 15% of the amount presented by the virtual bus object 13-5.

The case K2 acts to increase the fare for the virtual passenger object 13-6 and to reduce the fare for the virtual bus. Owing to this, there is a possibility of occurrence of the virtual passenger objects 13-6 abandoning the use of the special bus by this proposal, and that the virtual bus company cancels the service of special buses since an income of the special buses falls by the presence of the virtual passenger objects 13-6 abandoning the use thereof.

The virtual mediation section 13-7 repeatedly conducts mediation between each virtual passenger object 13-6 and the virtual bus object 13-5 on the basis of mediation policies of the cases K1 and K2, the virtual passenger objects 13-6 and the virtual bus object 13-5 between which an agreement of the mediation is reached finally remain, and the virtual service phase 4-3 of FIG. 5 is completed.

Next, in the actual service phase 4-4 of FIG. 5, actual mediation is conducted by presenting the amount determined by the virtual mediation to each actual passenger and the actual bus company. Basically, it is possible to prevent an increase in actual mediation time by merely asking if the actual passenger and the actual bus company accept the amount. It is to be noted, however, the same rules as those specified in the virtual mediation described above may be used in the actual mediation.

Furthermore, at a time of conducting the actual mediation, details of the virtual mediation may be presented to each actual passenger and the actual bus company. The actual passenger and the actual bus company can thereby know of a background of the virtual mediation and use the background in determining whether or not to accept the virtual mediation result.

In a case of a failure in the actual mediation, it is possible to change the mediation correction coefficient corresponding to each virtual passenger object 13-6 or the virtual bus object 13-5. It is thereby possible to reset conditions for both the actual passenger and the actual bus company to be capable of accepting the virtual mediation result.

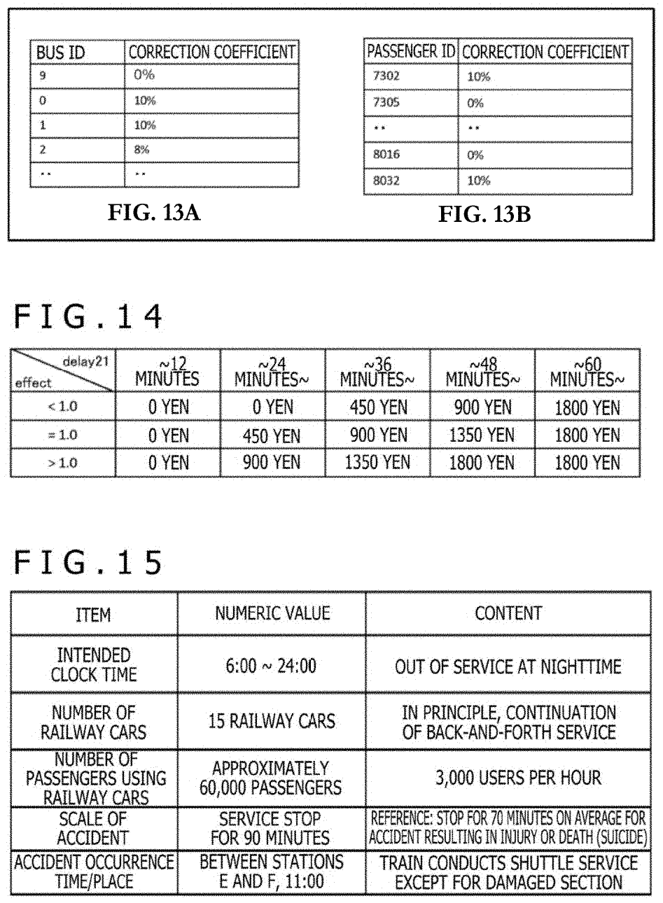

FIGS. 13A and 13B are diagrams depicting correction coefficient tables used in the mediation coefficient correction section 13-3 of FIG. 4.

In the correction coefficient table of FIG. 13A, a unique bus ID for identifying each bus and a fare discount rate in a case in which a bus company provides special buses are set. At this time, the discount rate may vary depending on the bus ID.

In the correction coefficient table of FIG. 13B, a unique passenger ID for identifying each passenger and a fare discount rate in a case in which the passenger uses a special bus are set. At this time, the discount rate may vary depending on the passenger ID.

FIG. 14 is a diagram depicting a fuzzy rule table changed on the basis of the correction coefficient tables.

FIG. 14 depicts an example in which all amounts described in the fuzzy rule table of FIG. 12 are reduced by 10%.

Even in a case of a failure in mediation at the time of using the fuzzy rule table of FIG. 12, using the fuzzy rule table of FIG. 14 can contribute to the fare reduction for each passenger. This can facilitate passenger's accepting the mediation proposal.

Furthermore, by causing the fare to be reduced for each passenger, it is possible to increase the number of passengers accepting to use the special bus. This can suppress a reduction in a total fare that can be collected from the passengers using the special bus. Moreover, it is possible to increase the total amount that can be collected from the passengers using the special bus in a case in which the number of passengers accepting to use the special bus greatly increases by causing the fare to be reduced for each passenger.

FIG. 15 is a diagram depicting specific examples of an environmental condition during railway services applied to the resource mediation system of FIG. 2.

In FIG. 15, items are set for the environmental condition during railway services. As the items, an intended clock time, the number of railway cars, the number of passengers using the railway cars, an accident scale, and accident occurrence time/place can be set. A numeric value and a content can be set per item. The new transportation generation plan solver 13-1 can refer to the environmental condition at a time of formulating the new transportation generation plan.

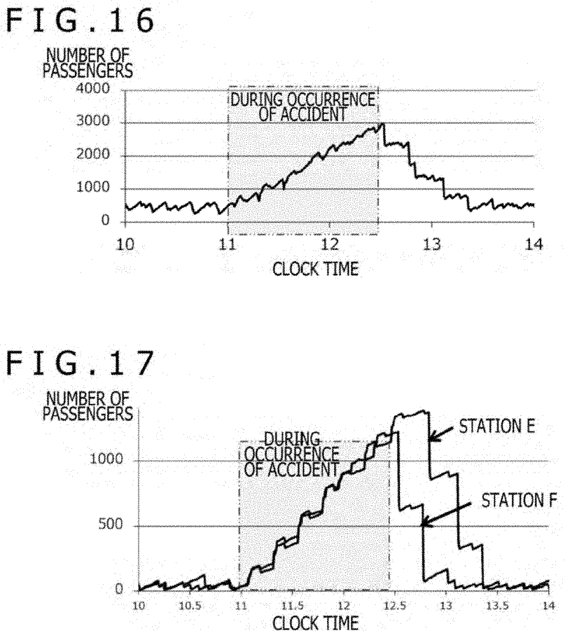

FIG. 16 is a graph chart depicting a change in the number of passengers in a railway car on the move during occurrence of the railway car stop accident.

It is understood from FIG. 16 that the railway car is stopped and the number of passengers increases during the occurrence of the railway car accident. The example of FIG. 16 illustrates a case in which the railway car accident has occurred at 11:11 and the railway car service has been stopped for ninety minutes in accordance with the environmental condition of FIG. 15.

FIG. 17 is a graph chart depicting the numbers of passengers sojourning at the stations E and F of FIG. 1.

In FIG. 17, the passengers are forced to stay at the stations E and F because of occurrence of a situation in which there exist passengers beyond a capacity of the railway car and/or there is no presence of the railway car arriving at destinations during the occurrence of the railway car accident. It is understood that a circumstance is that the passengers necessary to goes through the stations E and F are forced to get off the railway car at the stations E and F due to the occurrence of the accident between the stations E and F.

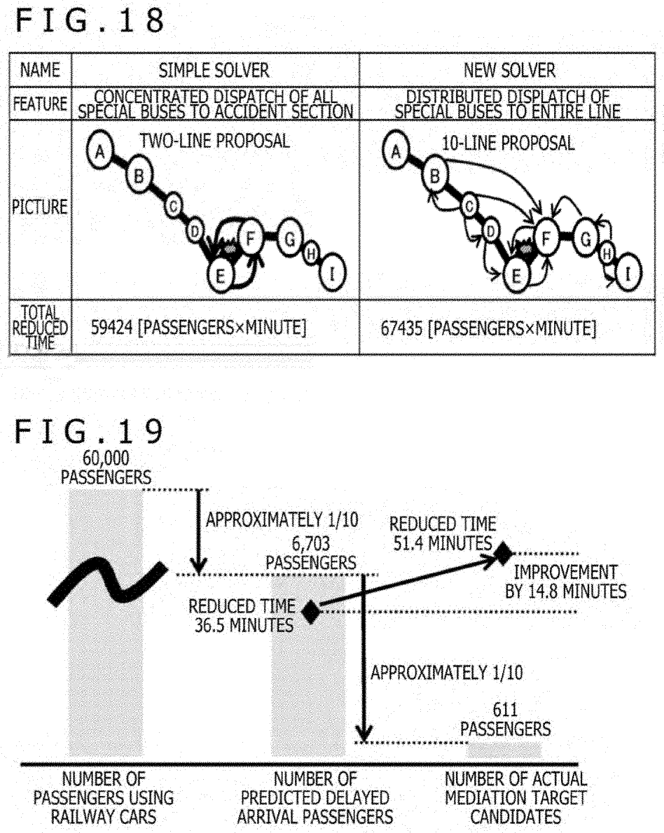

FIG. 18 is a diagram depicting special bus service plan proposals produced by the resource mediation system of FIG. 2.

In FIG. 8, a special bus service plan proposal (simple solver) in sections of the railway car stop accident and a special bus service plan (new solver) produced by an algorithm based on FIG. 10 are compared with each other.

In a simple scheme by the simple solver, all buses available during the railway car accident are dispatched to the section between the stations E and F. In the simple scheme, there are cases in which the buses are moved to the stations E and F from other stations but in which it takes lots of time to move the buses and the buses are incapable of acting as transit power before the recovery from the accident.

On the other hand, with the service plan by the new solver, it is possible to instantly dispatch buses available at the stations A to I to the stations A to I. It is, therefore, possible for the buses available at the time of the railway car stop accident to act as a complement to railway transportation over the entire railway line P1. According to a simulation result before the mediation, the new solver could attain an improvement of approximately 12.7% for a value obtained by multiplying the total number of transported passengers by reduced time.

FIG. 19 is a diagram depicting time reduced by actual special buses proposed by the resource mediation system of FIG. 2.

FIG. 19 depicts number of virtual passenger objects 13-6 subjected to the virtual mediation out of the number of passengers using the railway cars (60,000) given in the environmental condition of FIG. 15 and reduced time of delay time achieved by the virtual buses, and the number of actual passengers subjected to the actual mediation and reduced time of the delay time achieved by the actual special buses.

The new solver of FIG. 18 calculates passengers predicted to be late for arrival at destinations in the actual world, and conducts mediation between each of the passengers as the virtual passenger object 13-6 and the virtual bus object 13-5. A mediation result indicates that the number of passengers predicted to agree with the actual mediation is approximately 600 and that the mediation with approximately one-tenth of the number of predicted delayed arrival passengers or approximately one-hundredth of the number of passengers using the railway cars is enough. The result also indicates that actual mediation target candidates are expected to have a reduction in delayed arrival time by approximately fifteen minutes, compared with the predicted delayed arrival passengers.

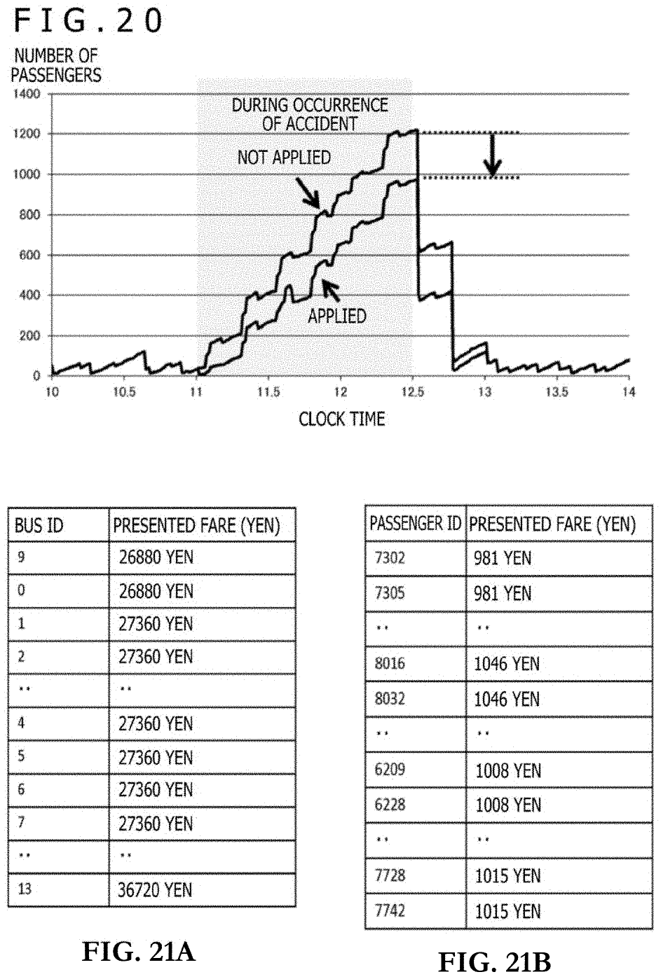

FIG. 20 is a diagram depicting changes in the number of passengers sojourning at the station F depending on whether or not the service plan proposal produced by the resource mediation system of FIG. 2 is applied.

It is understood from FIG. 20 that the number of passengers sojourning at the station F in a case of applying the service plan proposal is smaller than that in a case of not applying the service plan proposal. The actual mediation after the virtual mediation by the resource mediation system can improve passenger transportation efficiency.

FIGS. 21A and 21B are diagrams depicting fares on which an agreement is reached in the virtual mediation by the resource mediation system of FIG. 2.

In FIG. 21A, the virtual bus object 13-5 can present a fare per bus ID in the case of providing special buses.

In FIG. 21B, the virtual passenger object 13-6 can present a fare per passenger ID in the case of using a special bus by a passenger.

The virtual mediation makes rough fares clear before the actual mediation and can prevent useless repetition of mediation at the time of the actual mediation. Furthermore, offering the details of the virtual mediation to each actual passenger and the actual bus company enables both the actual passenger and the actual bus company to have a feeling of agreement and enables smooth transition to the actual mediation.

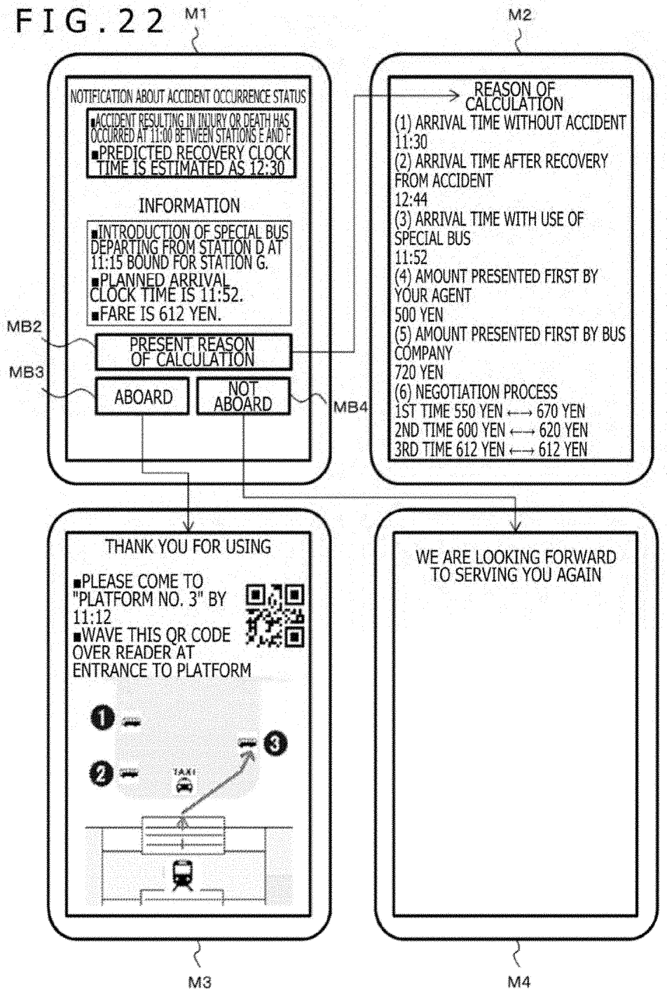

FIG. 22 is a diagram depicting examples of a display screen of each information terminal 4 of FIG. 4.

In FIG. 22, the actual mediation message creation section 12-5 of FIG. 4 creates the mediation message addressed to each actual passenger on the basis of the mediation result from the virtual mediation section 13-7, and transmits the mediation message to each information terminal 4 via the message transmitting section 11-2.

When the information terminal 4 receives the mediation message, the mediation message is displayed on a display screen M1 of the information terminal 4. The mediation message can contain a predicted recovery clock time of the railway car, and a departure station and a terminal station, a departure clock time, a planned arrival clock time, and a fare of a special bus. In addition, a button MB2 for presenting a reason of calculation, a button MB3 for declaring acceptance to get aboard, and a button MB4 for declaring rejection to get aboard can be displayed on the display screen M1.

Upon passenger's selecting the button MB2, the display screen M1 transitions to a display screen M2 and the reason of calculation of the fare is displayed on the display screen M2. The reason of calculation can contain the progress of fare negotiation. Upon passenger's selecting the button MB3, the display screen M1 transitions to a display screen M3 and boarding procedures and the like can be displayed on the display screen M3. Upon passenger's selecting the button MB4, the display screen M1 transitions to a display screen M4 and an end message and the like can be displayed on the display screen M4.

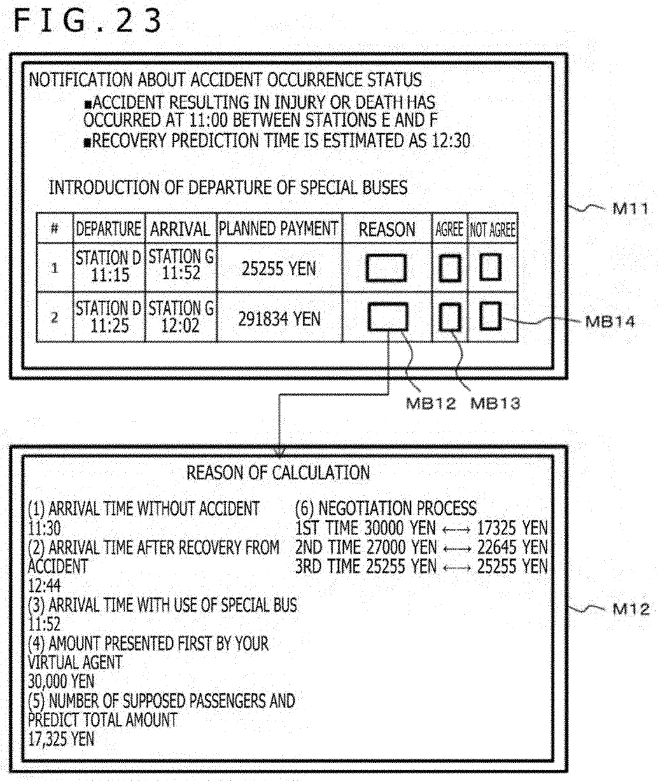

FIG. 23 is a diagram depicting examples of a display screen of the bus service server 3 of FIG. 4.

In FIG. 23, the actual mediation message creation section 12-5 of FIG. 4 creates the mediation message addressed to the actual bus company on the basis of the mediation result from the virtual mediation section 13-7, and transmits the mediation message to the bus service server 3 via the message transmitting section 11-2.

When the bus service server 3 receives the mediation message, the mediation message is displayed on a display screen M11 of the bus service server 3. The mediation message can contain the predicted recovery clock time of the railway car, and the departure stations and the terminal stations, the departure clock times, the planned arrival clock times, and planned amount of payments of special buses. In addition, a button MB12 for presenting a reason of calculation, a button MB13 for declaring acceptance of a special bus service, and a button MB14 for declaring rejection of the special bus service can be displayed on the display screen M11.

Upon bus company's selecting the button MB12, the display screen M11 transitions to a display screen M12 and the reason of calculation of fares is displayed on the display screen M12. The reason of calculation can contain the progress of fare negotiation. Upon bus company's selecting the button M13, special bus allocation procedures and the like can be displayed. Upon bus company's selecting the button M14, an end message and the like can be displayed.

In a second embodiment, a resource mediation method intended at a resource mediation target in a larger scale will be described while quoting the first embodiment.

In the first embodiment, processing from the resource virtual mediation to the actual mediation is continuously conducted and completed within actual time. In a case of continuously conducting the processing from the resource virtual mediation to the actual mediation, an increase in the number of types of mediation targets or in the number of mediation targets possibly makes it difficult to complete the processing from the virtual mediation to the actual mediation within actual time. The actual time mentioned herein is time required for the recovery from the occurrence of the railway car stop accident. Unless the actual mediation is completed before the recovery from the railway car stop accident, there is no benefit for passengers to use special buses.

In the second embodiment, therefore, patterns of accidents and resource generation are created in advance and stored in a database. In addition, after occurrence of an actual accident, a pattern similar to the actual accident is extracted from the database and actual mediation is carried out. It is thereby possible to carry out the actual mediation without conducting the virtual mediation in response to the actual accident, after the occurrence of the actual accident. Owing to this, it is possible to complete processing from the occurrence of the actual accident to the actual mediation within the actual time even in the case in which the number of types of mediation targets or the number of mediation targets increases.

An example of the environmental condition supposed in the resource mediation system according to the second embodiment is as follows.

Number of railway lines: approximately seven
Number of stops: approximately one hundred
Railway line distance: approximately 300 km
Total number of users: approximately 1,000,000 users/day
Service hours: approximately 18 hours/day
Number of available special buses: approximately five buses at each principal station having a bus terminal

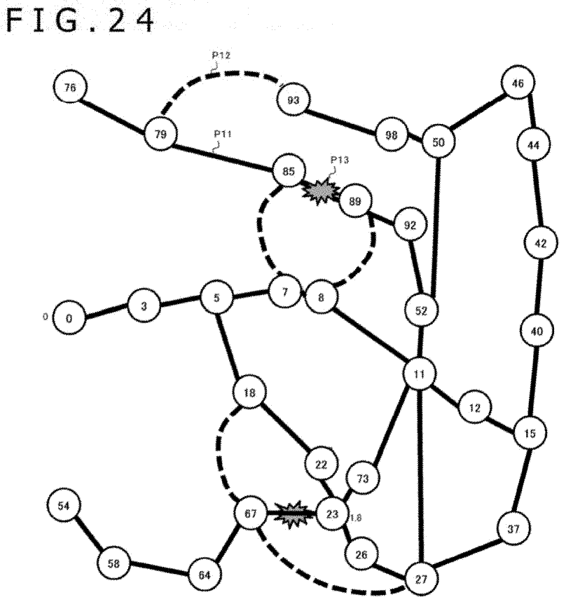

FIG. 24 is a diagram depicting an example of a special bus service line at a time of occurrence of an accident on a railway line according to the second embodiment.

FIG. 24 exemplarily depicts a railway line P11 when stations 0 to 99 are provided and a special bus service line P12 at a time of occurrence of a railway car accident P13. It is noted, however, that FIG. 24 depicts only the stations each having a bus terminal as nodes.

At the time of occurrence of the railway car accident P13, in a case of assuming free alternative transportation in a large-scale railway network as depicted in FIG. 24 as a mediation target, then it often takes several hours to perform virtual mediation processing and it is likely to be difficult to complete processing from virtual mediation to actual mediation within actual time. Owing to this, the resource mediation system according to the second embodiment conducts virtual mediation on the virtual space before occurrence of an actual railway car accident on the basis of railway car accidents that previously occurred on the railway network of FIG. 24. The virtual mediation is conducted while changing occurrence conditions for the railway car accident such as a point and a clock time at which the accident occurs and the occurrence scale. The railway car accidents that previously occurred on the railway network may be actual railway car accidents that previously occurred or virtual railway car accidents that simulatively, virtually occur on a simulation.

When this virtual mediation is conducted, accident information at that time, new transportation creation information, and post-virtual-mediation information are stored in such a manner that these pieces of information correspond to accident information about a railway car accident. The new transportation creation information contains a name of a bus company providing special buses, paths of the special buses, the number of the special buses, and the like determined in response to the occurrence conditions for the railway car accident. The post-virtual-mediation information contains the number of passengers using special buses, the paths of the special buses, and the like determined in response to the occurrence conditions for the railway car accident. Furthermore, in a case of occurrence of an actual railway car accident on the railway network of FIG. 24 after this virtual mediation, the new transportation creation information and the post-virtual-mediation information corresponding to occurrence conditions similar to those for the actual railway car accident are selected. In addition, actual mediation is carried out on the basis of the selected new transportation creation information and the selected post-virtual-mediation information.

It is thereby possible to carry out the actual mediation without carrying out the virtual mediation processing by the virtual mediation processing section 13 of FIG. 14 after the occurrence of the actual railway car accident on the railway network of FIG. 24. It is, therefore, possible to complete the processing from the occurrence of the actual railway car accident to the actual mediation within the actual time and realize mediation beneficial to both actual passengers and the actual bus company.

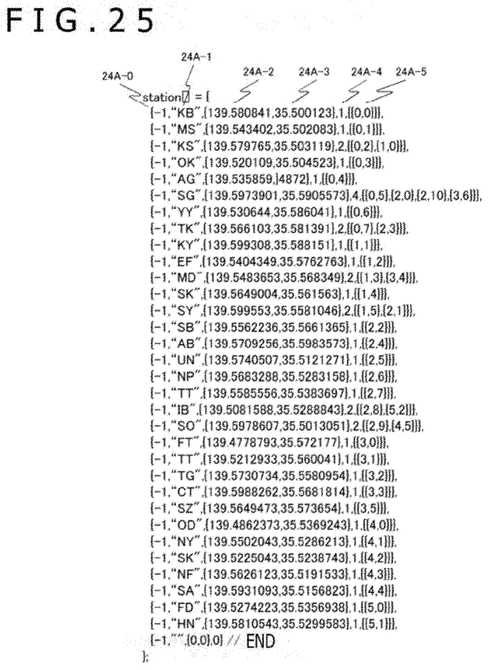

FIG. 25 is a diagram depicting station information about the stations of FIG. 24. The station information contains a station number 24A-0 unique to each of the stations 0 to 99, an abbreviation 24A-1 of a name of each station, latitude information 24A-2 about each station, longitude information 24A-3 about each station, the number of lines 24A-4 connected to each station, a set 24A-5 of a line number and a station number on the line (not the unique station number 24A-0).

The station number 24A-0 is assigned by a program afterward. The longitude information 24A-2 and the latitude information 24A-3 can be used to calculate a shortest-distance route. The number of lines 24A-4 and the set 24A-5 of the line number and the station number on the line can be used to express the railway network of FIG. 24 by a topology.

FIG. 26 is a block diagram depicting a flow of processing at a time of creating a virtual mediation result by the resource mediation server according to the second embodiment.

The resource mediation server of FIG. 26 is provided with a data write section 25-3 and a database D1 in addition to the configuration of FIG. 4.

In addition, this resource mediation server transitions to the virtual service phase 4-3 upon occurrence of a railway car stop accident 25-2. The railway car stop accident 25-2 may be an actual railway car accident or a virtual railway car accident that simulatively, artificially occurs on a simulation. A plurality of accident patterns of the railway car stop accident 25-2 can be artificially created by changing clock time of the accident occurrence, a place of the accident occurrence, an accident scale, time required for recovery, and the like. In this case, two or more railway car stop accidents 25-2 may virtually occur simultaneously.

In the virtual service phase 4-3 of FIG. 26, processing similar to that performed in the virtual service phase 4-3 of FIG. 5 is performed. In addition, the new transportation creation information and the post-virtual-mediation information are output from the virtual railway car object 13-4, the virtual bus object 13-5, each virtual passenger object 13-6, and the virtual mediation section 13-7 to the data write section 25-3. Furthermore, accident information about the railway car stop accident 25-2 is input to the data write section 25-3. The data write section 25-3 stores the new transportation creation information and the post-virtual-mediation information in the database D1 per accident information about the accident having changed occurrence conditions.

The times t1, t2, and t3 in the virtual service phase 4-3 of FIG. 26 correspond to the three cases (A) to (C) of FIG. 6, respectively. It is to be noted, however, it is often possible to create an avoidance route on the railway line of FIG. 24 unlike the railway line of FIG. 2 even with the occurrence of the railway car stop accident 25-2.

The shortest-distance route may be determined as this avoidance route using, for example, the Dijkstra's algorithm (shortest path problem), and thereafter, the arrival clock times t1, t2, and t3 may be calculated using the route. In a case of occurrence of the railway car stop accident 25-2, a distance between the stations between which the railway car stop accident 25-2 occurred may be set to a sufficiently large value (for example, 9,999.9 km). Such handling enables setting of a route for avoiding the section to the virtual passenger object 13-6.

In a case in which a path calculation result based on the Dijkstra's algorithm becomes a sufficiently large value (for example, exceeding 10,000 km) due to an influence of the large value as the distance between the stations described above, each virtual passenger may be made to continuously wait at the departure station upon determining that means for arriving at the intended station is not substantially present.

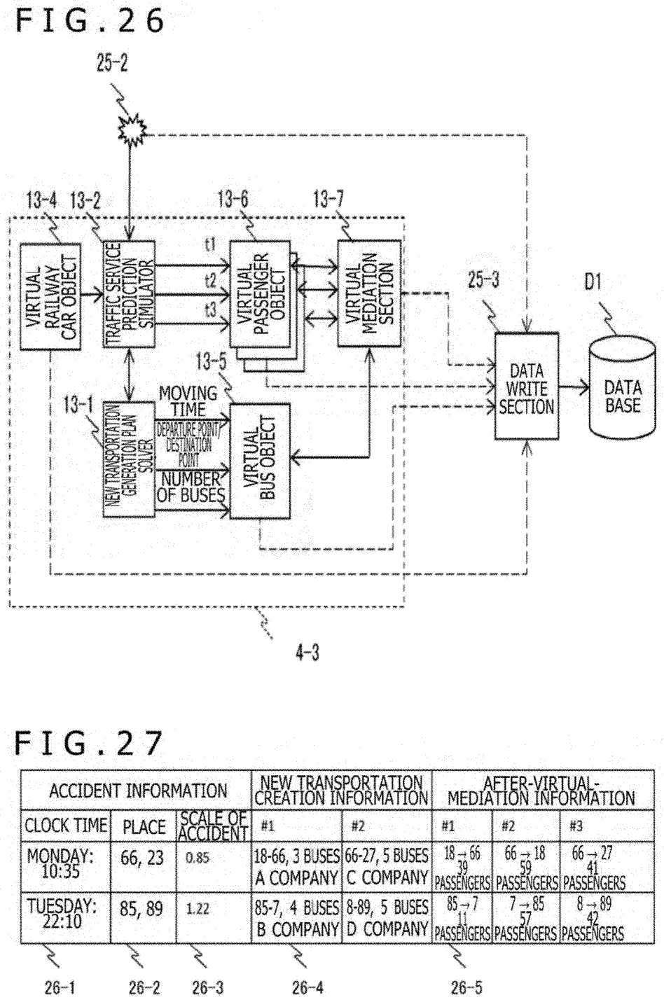

FIG. 27 is a diagram depicting an example of data stored in the database of FIG. 26 and generated at a time of artificial occurrence of railway car stop accidents while changing occurrence conditions for the railway car accident.

In FIG. 27, the database D1 stores therein, as accident information, an accident occurrence clock time 26-1, an accident occurrence place 26-2, and an accident scale 26-3. The accident scale 26-3 indicates time taken from occurrence of an accident until the recovery from the accident. It is described, for example, that when the accident occurrence clock time 26-1 is 10:35 on Monday, the accident occurrence place 26-2 is “66, 23” and the accident scale 26-3 is 0.85. “66, 23” indicates that the accident has occurred between the stations 66 and 23 of FIG. 26. 0.85 indicates that the recovery takes fifty-one minutes (=60 minutes×0.85) after the occurrence of the accident.

Moreover, the database D1 stores therein new transportation creation information 26-4 and post-virtual-mediation information 26-5. The new transportation creation information 26-4 can be created per section between stations to which special buses are provided. The post-virtual-mediation information 26-5 can be created for each of an outward path and a return path per section between stations to which special buses are provided. The new transportation creation information 26-4 and the post-virtual-mediation information 26-5 can be created per accident information changed in occurrence conditions. The new transportation creation information 26-4 is created by the new transportation generation plan solver 13-1, and the post-virtual-mediation information is created by the virtual mediation section 13-7.

In a case, for example, of an accident, the occurrence clock time 26-1 of which is 22:10 on Tuesday, “85-7, four buses, B company” is described in #1 of the new transportation creation information 26-4. This indicates a content to the effect that B company agreed to service four buses between the stations 85 and 7 in the virtual mediation. Furthermore, in the case of the accident the occurrence clock time 26-1 of which is 22:10 on Tuesday, “85→7, 11 passengers” is described in #1 of the post-virtual-mediation information 26-5. This indicates that the number of passengers who agreed to get aboard a bus moving from the station 85 to the station 7 in the virtual mediation is 11.

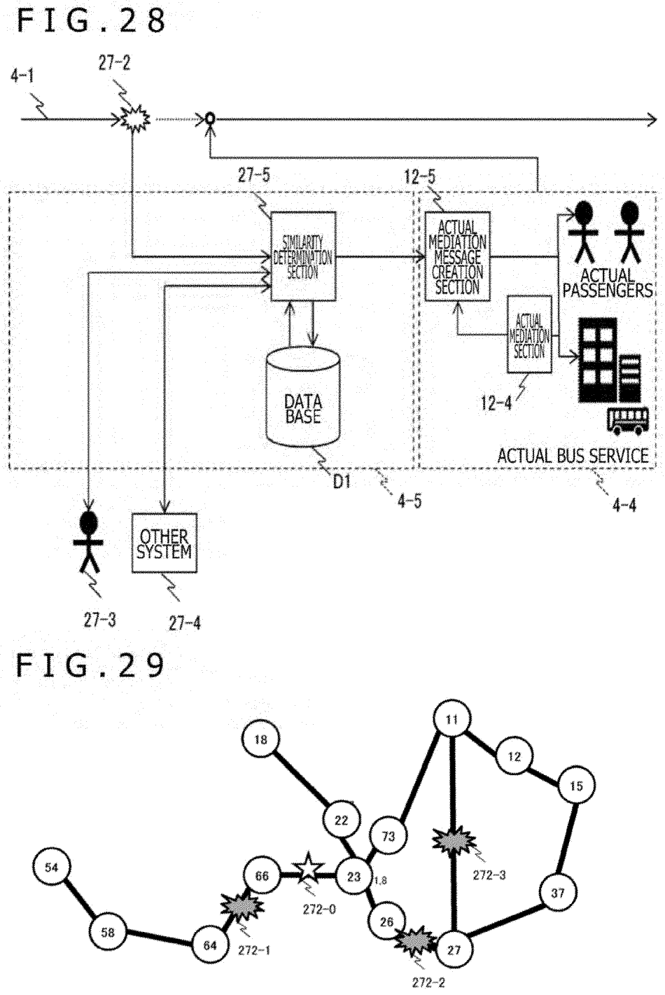

FIG. 28 is a block diagram depicting a flow up to actual mediation by the resource mediation server according to the second embodiment.

In FIG. 28, a similarity determination section 27-5 is added to the resource mediation server of FIG. 26. The similarity determination section 27-5 acquires the new transportation creation information and the post-virtual-mediation information associated with past accident information, the occurrence conditions for the past accident being similar to the occurrence conditions for the current railway car stop accident P13, from the database D1, and outputs the new transportation creation information and the post-virtual-mediation information to the actual mediation processing section 12. Actual mediation at the time of the occurrence of the railway car stop accident P13 can be carried out similarly to the actual mediation at the time of the occurrence of the railway car stop accident P3.

When the railway car stop accident P13 occurs at a clock time 27-2 on the time base 4-1 of the actual world, the resource mediation server of FIG. 28 skips the virtual service phase 4-3 of FIG. 5 and transitions to a similarity determination phase 4-5. In the similarity determination phase 4-5, accident information about the railway car stop accident P13 is input to the similarity determination section 27-5. It is noted herein that at the point in time of occurrence of the railway car stop accident P13, the accident occurrence clock time and the accident occurrence place are known but the time required for the recovery from the accident is unclear. Owing to this, the similarity determination section 27-5 may estimate time required for the recovery from the past accident information, or a person 27-3 outside of the present system and capable of determining a situation, the other system 27-4, or the like may input estimated time to the similarity determination section 27-5.

Upon input of the accident information about the railway car stop accident P13 to the similarity determination section 27-5, the similarity determination section 27-5 collates the input accident information to the accident information stored in the database D1. In a case in which information about an accident comparable to the current railway car stop accident P13 is stored in the database D1, the similarity determination section 27-5 acquires the information about the accident from the database D1. In a case of determining that information about an accident comparable to the current railway car stop accident P13 is not stored in the database D1, the similarity determination section 27-5 can acquire information about an accident most similar to the current railway car stop accident P13 from the database D1.

Alternatively, in the case of determining that information about an accident comparable to the current railway car stop accident P13 is not stored in the database D1, the similarity determination section 27-5 may generate information about an accident similar to the current railway car stop accident P13 on the basis of information about two or more accidents stored in the database D1. For example, the similarity determination section 27-5 extracts information about places approximate to position coordinates of the occurrence place of the current railway car stop accident P13 from the database D1, and generate similar information similar to the current railway car stop accident P13 from information about accidents corresponding to the places. This similarity information may be a value obtained by performing multiple regression calculation of the new transportation creation information and the post-virtual-mediation information extracted from the database D1 and summing up values each obtained by multiplying coefficients.

FIG. 29 is a diagram depicting an example of a relationship between points at which railway car accidents occurred in the past and a point at which the current railway car accident occurs, in the virtual mediation according to the second embodiment.

When the virtual mediation is conducted with respect to past railway car stop accidents 272-1, 272-2, and 272-3 depicted in FIG. 29, the accident information, the new transportation creation information, and the post-virtual-mediation information are stored in the database D1 via the data write section 25-3 as depicted in FIG. 27. When a current railway car stop accident 272-0 occurs, the similarity determination section 27-5 determines whether or not information about an accident comparable to the current railway car stop accident 272-0 is stored in the database D1. In a case of determining that information about an accident comparable to the current railway car stop accident 272-0 is stored in the database D1, the similarity determination section 27-5 acquires the information about the accident from the database D1. In a case of determining that information about an accident comparable to the current railway car stop accident 272-0 is not stored in the database D1, the similarity determination section 27-5 can acquire the information about the most similar accident to the current railway car stop accident 272-0 from the database D1.

In a case of assuming, for example, that occurrence conditions for the past railway car stop accident 272-1 closest to the occurrence place of the current railway car stop accident 272-0 are the most similar to the occurrence conditions for the current railway car stop accident 272-0, the similarity determination section 27-5 acquires the new transportation creation information and the post-virtual-mediation information about the railway car stop accident 272-1 from the database D1. The similarity determination section 27-5 then outputs the new transportation creation information and the post-virtual-mediation information about the railway car stop accident 272-1 to the actual mediation processing section 12. The actual mediation processing section 12 carries out actual mediation with respect to the railway car accident 272-0 on the basis of the new transportation creation information and the post-virtual-mediation information about the railway car accident 272-1.

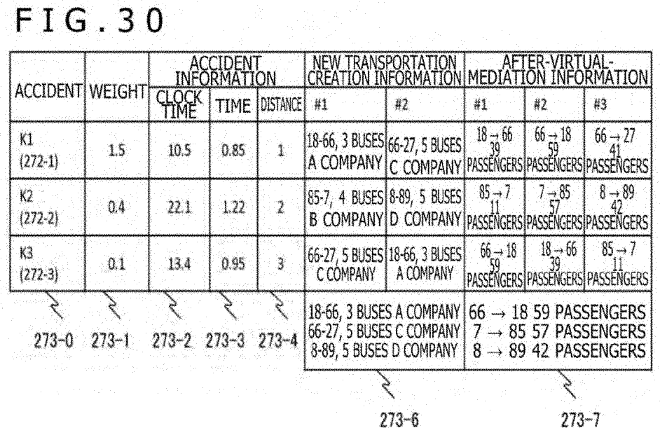

FIG. 30 is a diagram depicting examples of a method of calculating a virtual mediation result used in the actual mediation by the resource mediation server according to the second embodiment. It is noted that in FIG. 30, a case of creating new transportation creation information and post-virtual-mediation information about the current railway car stop accident 270-1 on the basis of the past railway car stop accidents 272-1, 272-2, and 272-3 around the current railway car stop accident 272-0 at a time of the occurrence of the current railway car stop accident 272-0 will be taken by way of example.

In FIG. 30, indexes K1 to K3 included in an index 273-0 are added to the railway car stop accidents 272-1, 272-2, and 272-3, respectively. An accident occurrence clock time 273-2, an accident duration 273-3, and an accident-to-accident distance 273-4 from an occurrence position of the current railway car stop accident 272-0 to each of the railway car stop accidents 272-1, 272-2, and 272-3 are entered to correspond to each of the indexes K1 to K3. The accident-to-accident distance 273-4 is a value that is the number of stations each having a bus terminal to replace the accident-to-accident distance.

The similarity determination section 27-5 calculates a weight 273-1 corresponding to each of the indexes K1 to K3 on the basis of the accident occurrence clock times 273-2, the accident durations 273-3, and the accident-to-accident distances 273-4 of the past railway car stop accidents 272-1, 272-2, and 272-3, and an accident occurrence clock time, an accident duration, and an accident-to-accident distance (which is zero in this case) of the current railway car stop accident 272-0. The weight 273-1 is set to be heavier as the occurrence conditions for the past railway car stop accident 272-1, 272-2, or 272-3 are closer to the occurrence conditions for the current railway car stop accident 272-0.

The similarity determination section 27-5 multiplies each of the new transportation creation information and the post-virtual-mediation information by the weight 273-1 of each of the indexes K1 to K3 and calculates a total of multiplication results, thereby calculating new transportation creation combined information 273-6 and post-virtual-mediation combined information 273-7. In the actual service phase 4-4 of FIG. 28, the actual mediation is carried out on the basis of new transportation creation combined information 273-6 and post-virtual-mediation combined information 273-7.

As described so far, according to the second embodiment, it is possible to conduct the actual mediation from a selection result of a virtual mediation pattern generated in advance before the occurrence of the current accident. Owing to this, even in the case of the increases in the number of types of mediation targets or in the number of mediation targets, it is possible to complete the processing from the occurrence of the current railway car accident to the actual mediation within the actual time, and to realize mediation beneficial to both the actual passengers and the actual bus company.

It is noted that a railway car stop accident other than the railway car stop accidents 272-1, 272-2, and 272-3 may simulatively, virtually occur and virtual mediation may be conducted for the railway car stop accident that simulatively, virtually occurs before the occurrence of the current railway car stop accident 272-0. In addition, accident information, new transportation creation information, and post-virtual-mediation information in the virtual mediation may be stored in the database D1. By simulative and virtual occurrence of the railway car stop accident, it is possible to store the accident information, the new transportation creation information, and the post-virtual-mediation information about the railway car stop accident that simulatively, virtually occurs between the stations 23 and 66 in the database D1 even in a case of no occurrence of an actual railway car stop accident between the stations 23 and 66. Owing to this, when the current railway car stop accident 272-0 occurred between the stations 23 and 66, the actual mediation can be carried out on the basis of the accident information, the new transportation creation information, and the post-virtual-mediation information about the railway car stop accident that simulatively, virtually occur between the stations 23 and 66.

By carrying out the virtual mediation for the railway car stop accidents that simulatively, virtually occur in advance and storing the information about the accidents in the database D1 herein, it is possible to acquire the information about the accident comparable to the actual railway car stop accident from the database D1 while handling every situation of the actual railway car stop accident.

A third embodiment is a method of handling a circumstance (rush hours, delay/delayed arrival) in which it is impossible to sufficiently provide a service according to a train schedule even without a circumstance of paralysis of railway car due to the accident resulting in injury or death or the like as in the first and second embodiments. The third embodiment is available in both of the first and second embodiments.

A passenger plans to get aboard for reducing boarding time. This is because the boarding time is a negative cost for the passenger. In a case in which a train moving velocity is uniform, the boarding time is equivalent to a train moving distance.

Since passenger's getting aboard a train in rush hours makes the passenger feel stress, this stress can be also calculated as a negative cost. If the passenger's stress can be calculated as the negative cost, the passenger's stress can be considered as one which increases a moving distance of the train that the passenger is in use. The train moving distance including such passenger's subjectivity will be referred to as “psychological virtual distance,” hereinafter.

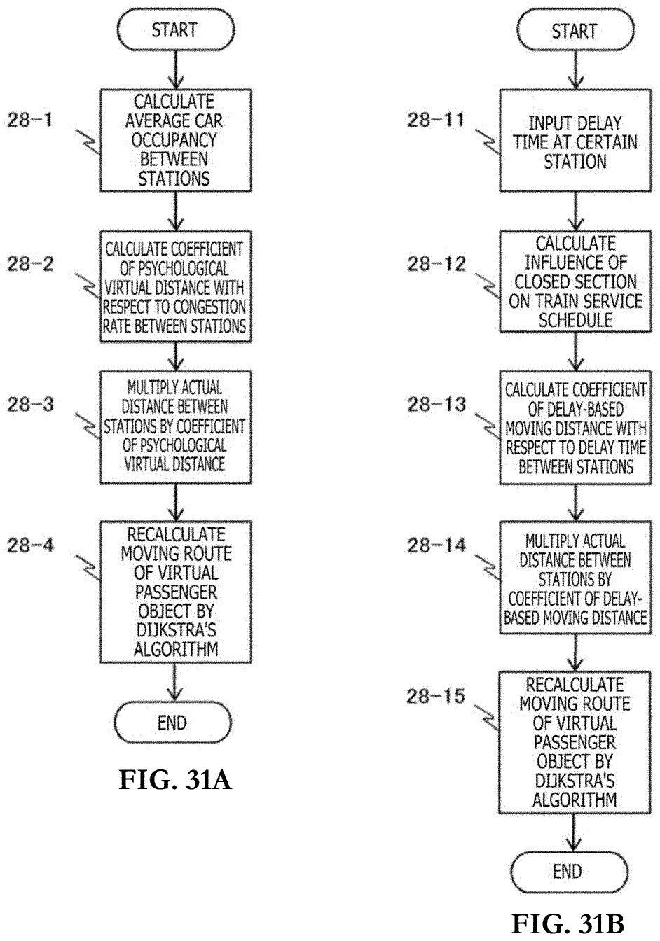

FIG. 31A is a flowchart depicting a method of calculating a psychological virtual distance during rush hours. In processing of FIG. 31A, a moving path of the virtual passenger object 13-6 is changed by reflecting person's psychology in the moving path at the time of calculating the arrival clock times t2 and t3 of FIG. 6.

In FIG. 31A, in Step 28-1, a railway car occupancy between stations is calculated using the virtual railway car object 13-4. As the car occupancy, an average value of a plurality of virtual railway car objects 13-4 traveling between stations at the point in time may be used.

Next, in Step 28-2, a coefficient of the psychological virtual distance with respect to a congestion rate between the stations is calculated. To calculate the coefficient KA, an equation of KA=max(1, 2(x−1)) (x: congestion rate), for example, can be used. In this equation, KA=1 at the car occupancy equal to or lower than 150%, and KA=3 at the car occupancy equal to 250%.

Next, in Step 28-3, the psychological virtual distance is calculated by multiplying an actual distance between the stations by the coefficient KA calculated in Step 28-2. Next, in Step 28-4, a route in which the psychological virtual distance is reflected is recalculated by using, for example, the Dijkstra's algorithm. The traffic service prediction simulator 13-2 predicts the arrival clock times t2 and t3 of each virtual passenger object 13-6 on the basis of the recalculated route. The virtual passenger object 13-6 presents whether or not the virtual passenger uses the virtual bus object 13-5 corresponding to a virtual special bus or presents a fare in the case of using the virtual bus object 13-5 on the basis of prediction of the arrival clock times t2 and t3.

Furthermore, an increase in time of stoppage at a station due to rush hours, a trouble between passengers, vomiting, or the like in the railway car has an influence on the passenger's arrival time. This can be also calculated as a negative cost for the passenger. If a delay in the arrival time can be calculated as the negative cost, the delay in the arrival time can be considered as one which increases the moving distance of the train that the passenger is in use. The moving distance by which the train can originally move without such a delay in the arrival time will be referred to as “delay-based virtual distance,” hereinafter.

FIG. 31B is a flowchart depicting a method of calculating a delay-based virtual distance during a train delay. In processing of FIG. 31B, the moving path of the virtual passenger object 13-6 is changed by reflecting a chain of stoppage of trains in the moving path by limiting stoppage of a certain railway car at a station for a long time and limiting closed sections of the other railway cars, at the time of calculating the arrival clock times t2 and t3 of FIG. 6.

In FIG. 31B, in Step 28-11, a train and a station are designated, and stoppage time is input. Next, in Step 28-12, an influence of a closed section on the other train service schedules is calculated.

Next, in Step 28-13, a coefficient of the delay-based virtual distance between the stations caused by delays in these trains is calculated. As this coefficient, a ratio related to a delay in passing time between the stations caused by these train delays can be used. To calculate the coefficient, an equation of KB=(average moving time between stations during occurrence of delay)/(average moving time between stations between which no delay occurs), for example, can be used. The (average moving time between stations during occurrence of delay) and the (average moving time between stations between which no delay occurs) can be calculated using the virtual railway car objects 13-4.

Next, in 28-14, the delay-based virtual distance is calculated by multiplying the actual distance between the stations by the coefficient KB calculated in Step 28-13. Next, in Step 28-15, a route in which the delay-based virtual distance is reflected is recalculated using, for example, the Dijkstra's algorithm. The traffic service prediction simulator 13-2 predicts the arrival clock times t2 and t3 of each virtual passenger object 13-6 on the basis of the recalculated route. The virtual passenger object 13-6 presents whether or not the virtual passenger uses the virtual bus object 13-5 corresponding to the virtual special bus or presents a fare in the case of using the virtual bus object 13-5 on the basis of prediction of the arrival clock times t2 and t3.

Description of Reference Characters
1: Resource mediation server
2: Railroad service server
3: Bus service server
1-01: CPU
1-02: Memory
1-03: Communication NIC
1-04: Hard disk drive
1-05: Input/output controller
1-06: Monitor controller
1-07: Bus
1-08: GPS module
1-11: Keyboard
1-12: Mouse
1-13: Display
13-1: New transportation generation plan solver
13-2: Traffic service prediction simulator
13-3: Mediation coefficient correction section
13-4: Virtual railway car object
13-5: Virtual bus object
13-6: Virtual passenger object
13-7: Virtual mediation section
12-1: Railway service resource information
12-2: Bus service resource information
12-3: Passenger resource information
12-4: Actual mediation section
12-5: Actual mediation message creation section
11-1: Message receiving section
11-2: Message transmitting section
20-1: Resource information providing section
20-2: Message transmitting section
20-3: Message receiving section
21-1: Mediation message creation section
21-2: Mediation message analysis section
21-3: Resource mediation section
22-1: Mediation message input section
22-2: Mediation message display section

1. A resource mediation system comprising:
a first server that sets a providing condition and a use condition for a second resource on a basis of a supply and demand state of a first resource, and that conducts mediation of supply and demand of the second resource on a basis of the providing condition and the use condition;
a second server that evaluates the providing condition for the second resource transmitted from the first server; and
an information terminal that evaluates the use condition for the second resource transmitted from the first server, wherein
the first server includes:
a virtual mediation processing section that virtually sets the use condition and the providing condition for the second resource on the basis of the supply and demand state of the first resource, and that conducts virtual mediation of the supply and demand of the second resource on the basis of the use condition and the providing condition for the second resource; and
an actual mediation processing section that conducts actual mediation of the supply and demand of the second resource on a basis of a result of the virtual mediation.

2. The resource mediation system according to claim 1, wherein
evaluation of the providing condition for the second resource is evaluation of whether or not the second resource is provided and evaluation of a fare of the second resource, and
evaluation of the use condition for the second resource is evaluation of whether or not the second resource is used and evaluation of a fare of the second resource.

3. (canceled)

4. The resource mediation system according to claim 1, wherein
the actual mediation processing section refrains from conducting the actual mediation in a case in which the virtual mediation is unsuccessful.

5. The resource mediation system according to claim 1, wherein
the virtual mediation processing section changes the providing condition and the use condition in a case of a failure in the actual mediation.

6. The resource mediation system according to claim 1, wherein
the virtual mediation processing section sets N (where N is an integer equal to or greater than 2) different providing conditions and N different use conditions, and conducts the virtual mediation on a basis of the N different providing conditions and the N different use conditions.

7. The resource mediation system according to claim 1, wherein
the virtual mediation processing section calculates a benefit at a time of using the second resource, and virtually sets the providing condition and the use condition on a basis of the benefit.

8. The resource mediation system according to claim 1, wherein
the virtual mediation processing section includes:
a prediction simulator that performs prediction of a service of the first resource and prediction of a service of the second resource;
a first virtual object that evaluates the use condition for the second resource on a basis of a result of the prediction of the service of the first resource and the prediction of the service of the second resource;
a second virtual object that evaluates the providing condition for the second resource on the basis the result of the prediction of the service of the second resource; and
a virtual mediation section that conducts the virtual mediation between the first virtual object and the second virtual object.

9. The resource mediation system according to claim 1, wherein
the first resource is a railway and the second resource is a bus, and
the first server
predicts a first arrival clock time in a case of no occurrence of a railway car accident, a second arrival clock time after recovery from the railway car accident, and a third arrival clock time in a case of using the bus before the recovery from the railway car accident on the basis of a damage scale due to the railway car accident, and
presents a use condition for the bus to a passenger and a providing condition for the bus to a bus company on a basis of prediction information about the first arrival clock time, the second arrival clock time, and the third arrival clock time, and conducts mediation of the number of special buses and a fare of each special bus between the passenger and the bus company.

10. The resource mediation system according to claim 1, wherein
the first resource is a railway and the second resource is a bus, and
the virtual mediation processing section includes:
a virtual railway car object that determines a position of a railway car on the move;
a traffic service prediction simulator that performs prediction of a service of the virtual railway car object;
a virtual bus object that determines whether or not a bus company provides a special bus or determines a fare of the special bus in a case of providing the special bus;
a virtual passenger object that determines whether or not a passenger uses the special bus or determines a fare of the special bus in a case of using the special bus;
a new transportation generation plan solver that formulates placement and a service plan of the virtual bus object; and
a virtual mediation section that conducts the virtual mediation between the virtual passenger object and the virtual bus object.

11. A resource mediation apparatus comprising:
a virtual mediation processing section that virtually sets a use condition and a providing condition for a second resource on a basis of a supply and demand state of the first resource, and that conducts virtual mediation of supply and demand of the second resource on a basis of the use condition and the providing condition for the second resource; and
an actual mediation processing section that conducts actual mediation of the supply and demand of the second resource on a basis of a result of the virtual mediation.

12. The resource mediation apparatus according to claim 11, wherein
the virtual mediation processing section includes:
a prediction simulator that performs prediction of a service of the first resource and prediction of a service of the second resource;
a first virtual object that evaluates the use condition for the second resource on a basis of a result of the prediction of the service of the first resource and the prediction of the service of the second resource;
a second virtual object that evaluates the providing condition for the second resource on the basis the result of the prediction of the service of the second resource; and
a virtual mediation section that conducts the virtual mediation between the first virtual object and the second virtual object on a basis of an evaluation result of the first virtual object and an evaluation result of the second virtual object.

13. The resource mediation apparatus according to claim 11, wherein
the virtual mediation processing section repeatedly conducts the virtual mediation in such a manner that an agreement is reached on the use condition and the providing condition for the second resource, and
the actual mediation processing section conducts the actual mediation on a basis only of a determination as to whether or not to accept the use condition and the providing condition for the second resource obtained in the virtual mediation.

14. The resource mediation apparatus according to claim 11, wherein
the first resource is a railway and the second resource is a bus, and
the virtual mediation processing section
predicts a first arrival clock time in a case of no occurrence of a railway car accident, a second arrival clock time after recovery from the railway car accident, and a third arrival clock time in a case of using the bus before the recovery from the railway car accident on a basis of a damage scale due to the railway car accident, and
presents a use condition for the bus to a passenger and a providing condition for the bus to a bus company on a basis of prediction information about the first arrival clock time, the second arrival clock time, and the third arrival clock time, and conducts mediation of the number of special buses and a fare of each special bus between the passenger and the bus company.

15. The resource mediation apparatus according to claim 11, wherein
the first resource is a railway and the second resource is a bus, and
the virtual mediation processing section includes:
a virtual railway car object that determines a position of a railway car on the move;
a traffic service prediction simulator that performs prediction of a service of the virtual railway car object;
a virtual bus object that determines whether or not a bus company provides a special bus or determines a fare of the special bus in a case of providing the special bus;
a virtual passenger object that determines whether or not a passenger uses the special bus or determines a fare of the special bus in a case of using the special bus;
a new transportation generation plan solver that formulates placement and a service plan of the virtual bus object; and
a virtual mediation section that conducts the virtual mediation between the virtual passenger object and the virtual bus object.

16. The resource mediation apparatus according to claim 11, further comprising:
a storage section that stores a past virtual mediation result by the virtual mediation processing section, wherein
the past virtual mediation result retrieved from the storage section is used in the actual mediation by the actual mediation processing section.

17. The resource mediation apparatus according to claim 14, further comprising:
a storage section that stores a past virtual mediation result by the virtual mediation processing section and accident information about the railway car accident in such a manner that the past virtual mediation result corresponds to the accident information; and
a similarity determination section that acquires the past virtual mediation result corresponding to the accident information similar to accident information about a current railway car accident from the storage section, and that outputs the past virtual mediation result to the actual mediation processing section, wherein
the actual mediation processing section conducts the actual mediation of the supply and demand of the second resource on a basis of the past virtual mediation result output from the similarity determination section.

18. The resource mediation apparatus according to claim 14, wherein
a virtual distance in which a congestion rate between stations is reflected in an actual distance between the stations, is calculated, and
the second arrival clock time and the third arrival clock time are predicted on a basis of the virtual distance.

19. The resource mediation apparatus according to claim 14, wherein
a virtual distance in which delay time of a train is reflected in an actual distance between the stations, is calculated, and
the second arrival clock time and the third arrival clock time are predicted on a basis of the virtual distance.
